(19) United States
(12) Patent Application Publication
(10) Pub. No.: US 2008/0198730 A1
(43) Pub. Date: Aug. 21, 2008

(54) Optical head and apparatus for optically recording and reproducing information

(75) Inventors: Hiromitsu Mori, Fujisawa (JP); Tomoto Kawamura, Tokyo (JP); Toshimasa Kamisada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Media Electronics Co., Ltd., Oshu-shi (JP)

(21) Appl. No.: 12/070,558

(22) Filed: Feb. 19, 2008

(30) Foreign Application Priority Data
Feb. 19, 2007 (JP) 2007-037292

(51) Int. Cl. G11B 7/00

(52) U.S. Cl. 369/112.23

(57) ABSTRACT

An optical sensor has first light receiving surfaces having respective pentagonal or hexagonal shapes and being independent of each other, and second light receiving surfaces having respective hexagonal shapes and being independent of each other, third light receiving surfaces having respective hexagonal shapes and being independent of each other, fourth light receiving surfaces having respective hexagonal shapes and being independent of each other, and fifth light receiving surfaces having respective hexagonal shapes and being independent of each other. A relationship between a size of each of the light receiving surfaces and a diameter of respective one of light beams received by corresponding one of the light receiving surfaces is set within a predetermined range. A light beam multiple-dividing element diffracts the light beams received by a first grating area to form +primary lights, and diffracts the light beams received by second and third grating areas to form +primary lights and −primary lights. Relationships of U/D and V/D are set within predetermined ranges.

### CLAIM OF PRIORITY

The present invention claims priority from Japanese application JP 2007-037292 filed on Feb. 19, 2007, the content of which is hereby incorporated by reference into this application.

### BACKGROUND OF THE INVENTION

The present invention relates to an optical head and an apparatus for optically recording and/or reproducing information.

JP-A-2006-344344 disclosing that a desired signal is read out from an optical disk including a plurality of recording layers is an example of the background of the invention. JP-A-2006-344380 disclosing that a tracking error signal with low offset is detected from an optical recording medium including two information recording surfaces is another example of the background of the invention. Shingaku-gihou CPM2005-149 (2005-10) (page 33ₜₕ and FIGS. 4 and 5) of Denshi-jouhou-tsuushin-gakkai disclosing that an optical sensor for tracking is arranged in a region to which stray light is prevented from being supplied from a non-target layer, is an example of the background of the invention.

### BRIEF SUMMARY OF THE INVENTION

In JP-A-2006-344344, a light beam reflected by an optical disk is condensed by a condensing lens, and the light beam passing two quarter wave length plates and a polarizing optical element while a diameter of the light beam is increased is condensed by another condensing lens to irradiate an optical sensor. Therefore, there is fear that a detecting optical system is complicated and has a large size. In JP-A-2006-344380, a diffraction grating is arranged to divide a laser beam emitted by a laser beam source to be supplied to one main spot and two sub-spots on a disk, and whereby there is fear that the laser beam is not effectively used to generate a main light beam for recording.

In Shingaku-gihou CPM2005-149 (2005-10) (page 33ₜₕ and FIGS. 4 and 5) of Denshi-jouhou-tsuushin-gakkai, the optical sensor for tracking is arranged at an outside of the stray light of light beam for focusing supplied from the unintended layer to the vicinity of an optical sensor for focusing, and the light diffracted at a central portion of a hologram element is directed to the outside of the stray light supplied from the unintended layer, so that there is fear that a size of an optical sensor is enlarged.

An object of the present invention is to provide an optical head capable of obtaining a stable servo-signal when recording information onto and/or reproducing the information from an information recording medium including a plurality of information recording faces, and an optical information recording and reproducing device on which the optical head is mounted.

The object is achieved by, for example, each of claims.

By the invention, the optical head capable of obtaining the stable servo-signal when recording the information onto and/or reproducing the information from the information recording medium including the plurality of information recording faces, and the optical information recording and reproducing device on which the optical head is mounted, are obtained.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1a is an upper view showing schematically an optical head for BD in embodiment 1, FIG. 1b is a view showing a pattern of a light receiving surface of a light receiving portion 112 of a BD optical sensor 109 in embodiment 1, and FIG. 1c is a view showing a grating dividing pattern of an optical beam multiple-dividing element 104 in embodiment 1.

FIGS. 2a-2c show light beams received by the light receiving portion 112 of the BD optical sensor 109 after an original light beam is diffracted by the optical beam multiple-dividing element 104 to be divided to the light beams in the embodiment 1.

FIGS. 3a-3c show a defocusing characteristic of the light beam received by the light receiving portion in embodiment 1.

FIGS. 4a-4b show calculated defocusing value and calculated intensity of each of the light beams received by the light receiving surface 301 after diffracted by respective grating surfaces A1 and E1 of the optical beam multiple-dividing element 104 under a predetermined size 310 of the light receiving surface 301 in the embodiment 1.

FIG. 5 shows a pattern of a light receiving surface of the light receiving portion 112 of the BD optical sensor 109 in the embodiment 1.

FIGS. 6a-6b show schematically a calculated change of the light beam received by each of the light receiving surfaces of an optical sensor when the light beam to be focused on a recording layer of an information recording medium changes from a focused condition to a defocused condition in the embodiment 1.

FIGS. 7a-7c show a fourth light receiving surface 506 for detecting a focusing error signal (FES) in the embodiment 1.

FIGS. 8a-8c show the optical beam multiple-dividing element 104 in the embodiment 1.

FIG. 9 shows schematically grating grooves 901 (shown by two-dot dashed lines) having respective grating angles shown on table 1 on respective grating areas of the optical beam multiple-dividing element 104 in the embodiment 1.

FIG. 10 shows a calculated distribution of unnecessary light received by the light receiving portion 112 of the BD optical sensor 109 after being reflected by non-target layer L1 in the embodiment 1.

FIG. 11 shows a calculated distribution of unnecessary light received by the light receiving portion 112 of the BD optical sensor 109 after being reflected by no-target layer L0 in the embodiment 1.

FIG. 12 is an upper view showing schematically an optical head for BD in embodiment 2.

FIGS. 13a-13c show a calculated return route magnification and a calculated area 309 even in intensity on a light receiving surface 503, 504 in the embodiment 2.

FIG. 14 is a graph showing a calculated relationship between the return route magnification and a detecting area 706 of the focusing error signal (FES) in the embodiment 2.

FIG. 15 is a graph showing a calculated relationship among a focal distance of focusing lens 1202, the return route magnification and a synthetic focal distance of detecting lens system (106, 105, 1201) in the embodiment 2.

FIG. 16 shows a pattern of a light receiving surface of the light receiving portion 112 of the BD optical sensor 109 in the embodiment 3.

FIGS. 17a-17b show a calculated distribution of unnecessary light received by the light receiving portion 112 of the BD optical sensor 109 after being reflected by non-target layer L1 in the embodiment 3.

FIGS. 18a-18b show a calculated distribution of unnecessary light received by the light receiving portion 112 of the BD optical sensor 109 after being reflected by non-target layer L0 in the embodiment 3.

FIG. 19 shows a pattern of grating formed on a light beam multiple-dividing element 1901 in the embodiment 4.

FIGS. 20a-20b show a calculated distribution of unnecessary light received by the light receiving portion 112 of the BD optical sensor 109 after being reflected by non-target layer L1 in the embodiment 4.

FIGS. 21a-21b show a calculated distribution of undesired light received by the light receiving portion 112 of the BD optical sensor 109 after being reflected by non-target layer L0 in the embodiment 4.

FIGS. 22a-22b show a modified pattern shape of the grating of the optical beam multiple-dividing element in the embodiment 5.

FIG. 23 is an upper view showing a three-wavelengths compatible optical head for BD/DVD/CD in embodiment 6.

FIG. 24 shows an optical information reproducing device or optical information recording and reproducing device including the above optical head in embodiment 7.

### DETAILED DESCRIPTION OF THE INVENTION

Hereafter, embodiments of the invention are described.

### First Embodiment

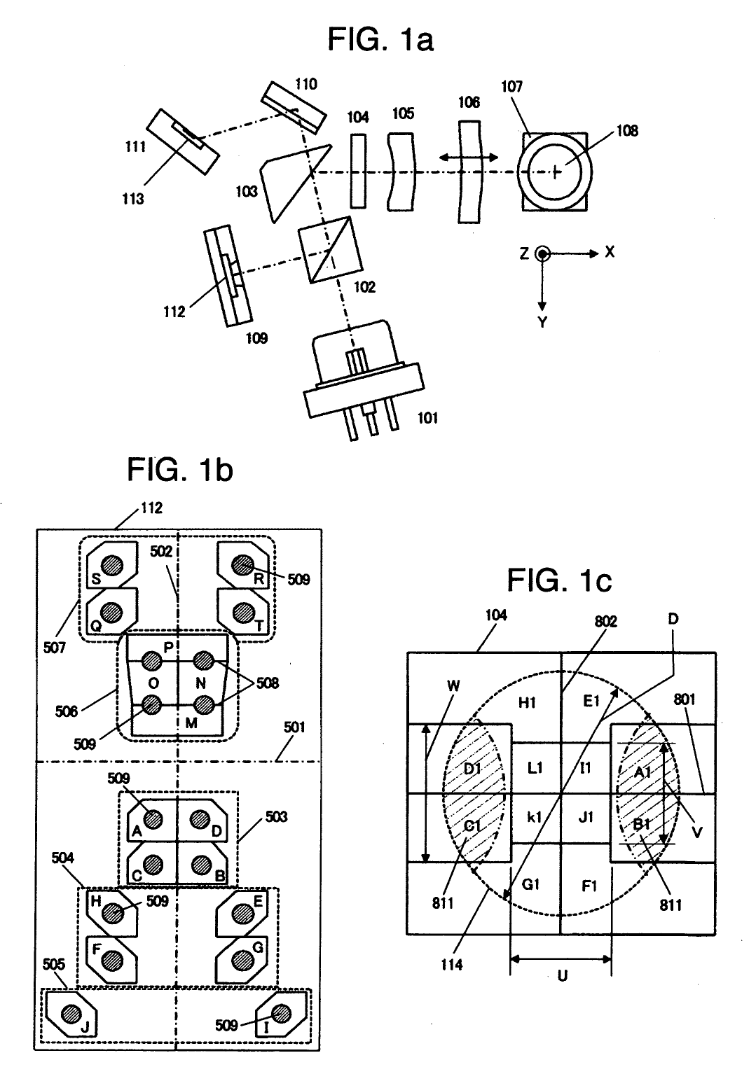

A first embodiment of the invention is described with making reference to FIGS. 1a-11b. Regarding this embodiment, a basic structure of an optical head for BD is described with making reference to FIGS. 1a-1c. Incidentally, the embodiment does not need to be used only for BD, and is applicable to, for example, an optical head for HD DVD, a compatible optical head for BD/DVD/CD, or the like.

FIG. 1a is an upper view showing schematically the optical head for BD. A light beam with band of 405 nm as a divergent linearly polarized light is emitted from a BD laser beam source 101, passes a polarizing beam splitter 102, a BD reflection mirror 103 and an optical beam multiple-dividing element 104 and a BD assistant lens 105, and is converted to a collimated light beam as a substantially-parallel light beam by a BD collimating lens 106. The BD collimating lens 106 is driven along an optical axis by a BD collimating lens driving mechanism (not shown) as shown by an arrow mark. Further, the BD collimating lens 106 includes diffracting grooves on a surface thereof to compensate a chromatic aberration caused by a temporary variation in wavelength generated by the BD laser beam source 101. The optical beam multiple-dividing element 104 includes a polarizing grating (not shown) and a quarter wave length plate (not shown) adhered to each other so that the polarizing grating (not shown) enables a linearly polarized light beam of a predetermined direction to be diffracted and another linearly polarized light beam of a direction perpendicular to the predetermined direction to pass through the polarizing grating. Therefore, the optical beam multiple-dividing element 104 enables the light beam of +X direction directed in FIG. 1a from left to right to pass through the optical beam multiple-dividing element 104 and the light beam of −X direction directed in FIG. 1a from right to left to be diffracted. In other words, the light beam emitted from the BD reflection mirror 103 passes through the polarizing grating (not shown) of the optical beam multiple-dividing element 104 without being diffracted, and converted to a circularly polarized light beam by the quarter wave length plate (not shown). The light beam emitted from the BD collimating lens 106 is reflected by a BD bending mirror 107 to be directed into +Z direction and focused by a BD objective lens 108 onto an information recording medium such as a data layer of BD.

The light beam reflected by the data layer of BD passes through the BD objective lens 108, the BD bending mirror 107, the BD collimating lens 106 and the BD assistant lens 105 to reach the optical beam multiple-dividing element 104. The light received by the optical beam multiple-dividing element 104 is converted from the circularly polarized light beam to the linearly polarized light beam of the direction perpendicular to that of the linearly polarized light beam proceeding from the BD laser beam source 101 to the optical beam multiple-dividing element 104, and subsequently divided to a plurality of light beams by the polarizing grating. These plurality of light beams proceed through the BD reflection mirror 103 and the polarizing beam splitter 102 to be received by a light receiving part 112 of a BD optical sensor 109. In this embodiment, as systems for detecting servo signals, a knife-edge method is used for a focusing error signal (hereafter called as FES), and a push-pull method is used for a tracking error signal (hereafter called as TES). Incidentally, the knife-edge method and the push-pull method as well known techniques are not explained here. The plurality of light beams received by the light receiving part 112 of the BD optical sensor 109 are used to obtain information signals corresponding to the information recorded by the data layer, control signals TES and FES for positioning the focused spot on the information recording medium, and so forth.

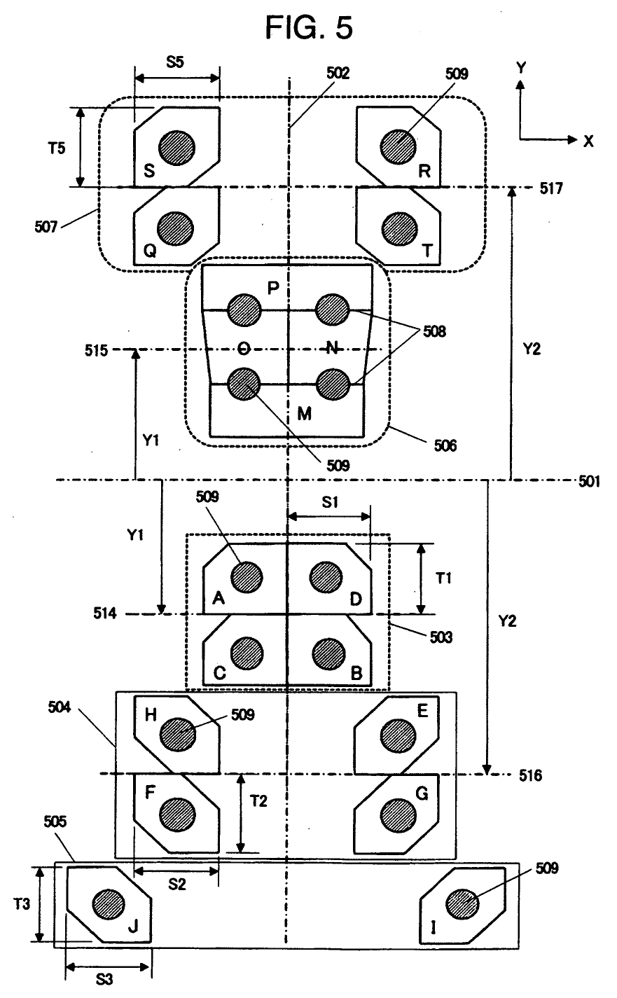

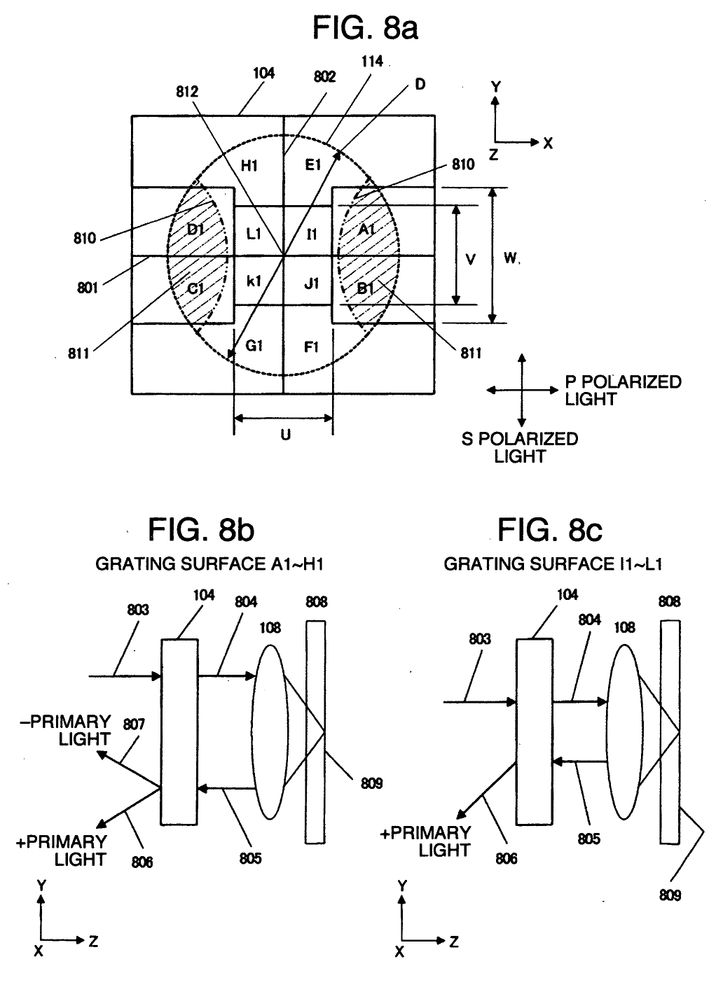

Hereafter, an optical path from the BD laser beam source 101 to the data layer of BD is called as an approach route, and an optical path from the data layer of BD to the BD optical sensor 109 is called as a return route. A size of the focused spot on the BD data layer varies in accordance with a numerical aperture (NA) of the objective lens and a wavelength of the BD laser beam source 101 as well as a magnification of the approach route (a synthetic focal distance of the BD assistant lens 105 and the BD collimating lens 106÷a focal distance of the BD objective lens 108) so that the size of the focused spot is decreased by increasing the magnification of the approach route. Therefore, in this embodiment, for simplifying the optical system, the light beam emitted by the BD laser beam source 101 is without beam shaping and the magnification of the approach route is about 12. Incidentally, in this embodiment, the BD assistant lens 105 and the BD collimating lens 106 are used to focus on the light receiving part 112 of the BD optical sensor 109 the light beam reflected by the BD data layer so that a magnification of the return route is equal to the magnification of the approach route. The BD objective lens 108 has a numerical aperture of 0.85 to decrease the size of the focused spot on the BD data layer in the BD optical system. On the other hand, since a spherical aberration caused by an error in thickness of a cover layer (not shown) of the BD data layer increases in proportion to biquadrate of the numerical aperture, a means for compensating the spherical aberration is needed in the BD. In this embodiment, for downsizing and simplifying, a beam expander (including a concave lens and a convex lens to enlarge a received collimated beam to be emitted) is not used, but the BD collimating lens 106 is driven along the optical axis by a spherical aberration compensating mechanism (not shown) to convert the light beam to be received by the BD objective lens 108 from the collimated beam to a slightly divergent or convergent beam to compensate the spherical aberration. A movable range and spherical aberration compensating sensitivity of the BD collimating lens 106 depend on a focal distance of the BD collimating lens 106 so that the shorter this focal distance is, the smaller the movable range is and the higher the spherical aberration compensating sensitivity is. In this embodiment, with considering this relationship, the focal distance of the BD collimating lens 106 is about 10 mm. Further, a part of the light beam emitted from the BD laser beam source 101 other than another part thereof within a effective diameter of the BD objective lens 108 proceeds over the BD reflection mirror 103, and is reflected by a reflector 110 to be received by a light receiving portion 113 of a front monitor 111. The front monitor 111 detects an intensity of the light beam emitted from the BD laser beam source 101 to feedback the detected intensity to a control circuit (not shown) for the BD laser beam source 101 so that the light beam of a desired intensity is applied to the information recording medium. FIG. 1b shows a pattern of light receiving surface of the light receiving portion 112 of the BD optical sensor 109. A first light receiving surface 503 divided to pentagonal or hexagonal regions A-D is arranged on one of sides with respect to a first imaginary central axis 501 corresponding to a radial direction of the information recording medium and being parallel to the radial direction of the information recording medium, a second light receiving surface 504 divided to hexagonal regions E-H is arranged at an outer side of the first light receiving surface 503 (farther than the first light receiving surface 503 from the first imaginary central axis 501), and a third light receiving surface 505 divided to hexagonal regions I and J is arranged at an outer side of the second light receiving surface 504 (farther than the second light receiving surface 504 from the first imaginary central axis 501). Further, a fourth light receiving surface 506 divided to two rectangular regions M and P and two trapezoidal regions N and O is arranged on the other one of the sides with respect to the first imaginary central axis 501, and a fifth light receiving surface 507 divided to hexagonal regions Q-T is arranged at an outer side of the fourth light receiving surface 506 (farther than the fourth light receiving surface 506 from the first imaginary central axis 501). Hatched circles 509 show respective light beams received by the light receiving portion 112 of the BD optical sensor 109 after being reflected by the BD data layer when the light beam is focused on the BD data layer. FIG. 1b is explained in detail below with making reference to FIG. 5. FIG. 1c shows a pattern of grating of the optical beam multiple-dividing element 104. The grating is divided to a plurality of grating surfaces A1-L1 by a first imaginary line 801 traversing two push-pull regions 811 (hatched) where zero-order light and +primary lights reflected and diffracted by the information recording medium overlap each other and being substantially parallel to the radial direction of the information recording medium and a second imaginary line 802 perpendicular to the first imaginary line 801. An area 114 denoted by a dot line shows a diameter of the light beam received by the optical beam multiple-dividing element 104. FIG. 1c is explained in detail below with making reference to FIG. 8.

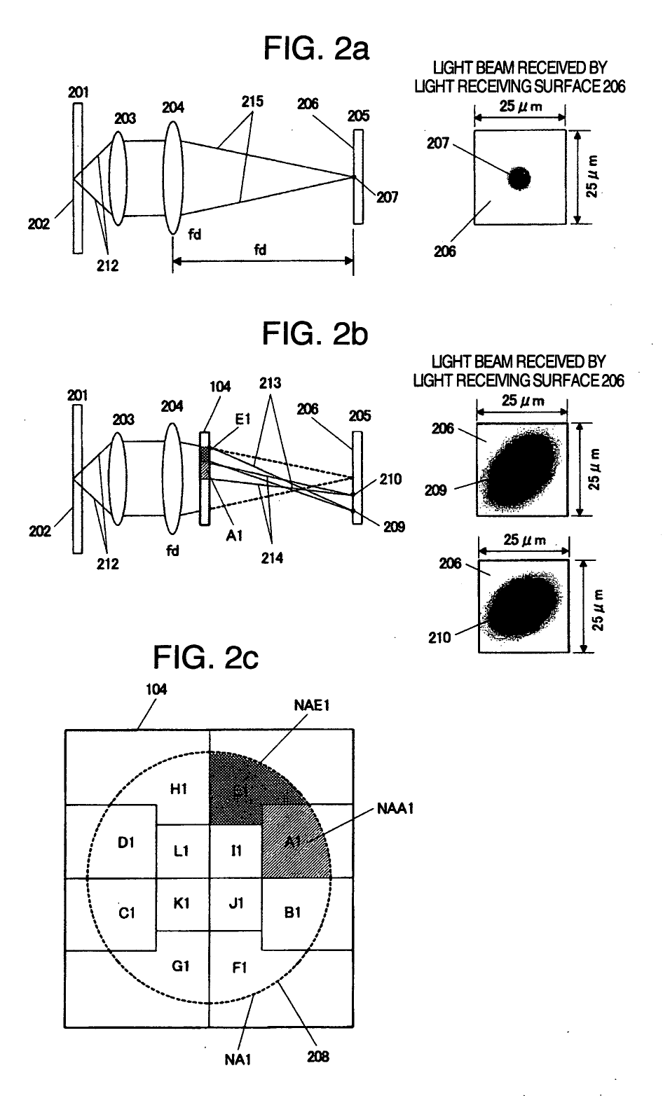

The light beams to which the light beam is divided and diffracted by the optical beam multiple-dividing element 104 to be received by the light receiving portion 112 of the BD optical sensor 109 are explained below with making reference to FIGS. 2a-2c. FIG. 2a shows the light received by the light receiving portion 112 without passing through the optical beam multiple-dividing element 104, in which a light beam 212 reflected by a recording surface 202 of an information recording medium 201 proceeds through an objective lens 203, and is focused by a detecting lens 204 having focal distance fd to be converted to a light beam 215 focused on a light receiving surface 206 of a optical sensor 205 to form a light beam 207. The light beam 207 forms necessarily a spot in accordance with a geometrical-optical calculation of the light beam along the optical path thereof, but forms actually a limited area under an influence of the diffraction. FIG. 2a shows at a right side view thereof obtained on the basis of the optical calculation with taking the diffraction into consideration the light beam 207 received by the light receiving surface 206 and having a diameter of about 5 μm. FIG. 2b shows a case where the optical beam multiple-dividing element 104 is arranged, and FIG. 2c shows grating surfaces of the optical beam multiple-dividing element 104. The light beams diffracted by the grating surface E1 as denoted by a hatching and the grating surface A1 as denoted by another hatching are explained below. In FIG. 2b, the light beam 212 reflected by the recording surface 202 of the information recording medium 201 proceeds through the objective lens 203, and diffracted by the detecting lens 204 having the focal distance fd and the grating surface E1 of the optical beam multiple-dividing element 104 to be converted to the light beam 213. Subsequently, the light beam 213 is focused on the light receiving surface 206 of the optical sensor 205 to form the light beam 209. Similarly, the light beam 212 diffracted by the grating surface A1 of the optical beam multiple-dividing element 104 is converted to the light beam 214. Subsequently, the light beam 214 is focused on the light receiving surface 206 of the optical sensor 205 to form the light beam 210. The light beams 209 and 210 form necessarily respective spots in accordance with the geometrical-optical calculation of the light beam along the optical path thereof, but form actually the limited areas respectively under the influence of the diffraction. FIG. 2b shows at a right side view thereof obtained on the basis of the optical calculation with taking the diffraction into consideration the light beams 209 and 210 on the light receiving surface 206, and each of the beams 209 and 210 has a diameter of about 25 μm. That is, the diameter of each of the beams 209 and 210 is fifth time of the diameter of the light beam 207. This is caused by that as shown in FIG. 2c, the light beam 208 is supplied to each of the grating surfaces A1 and E1 of the optical beam multiple-dividing element 104 so that a numerical aperture NAA1 of the grating surface A1 and a numerical aperture NAE1 of the grating surface E1 are smaller than a numerical aperture NA1 for the light beam 208. Generally, a diameter D of the focused light beam is calculated along the following formula from a wavelength λ and a numerical aperture NA. Incidentally, α is a constant determined from an angular distribution of an emitted laser.

D=α×λ/NA [formula 1]

Each of the actual numerical aperture NAA1 of the grating surface A1 and the actual numerical aperture NAE1 of the grating surface E1 as shown in FIG. 2c is about one fifth of the numerical aperture NA1 for the light beam 208. Therefore, as obtained from the above formula 1, the diameter of each of the light beam 209 and the light beam 210 is about five times of the diameter of the light beam 207. In this drawing, the explanation is performed on the grating surface A1 and the grating surface E1, but the similar explanation is applicable to each of the other grating surfaces B1-D1 and F1-L1.

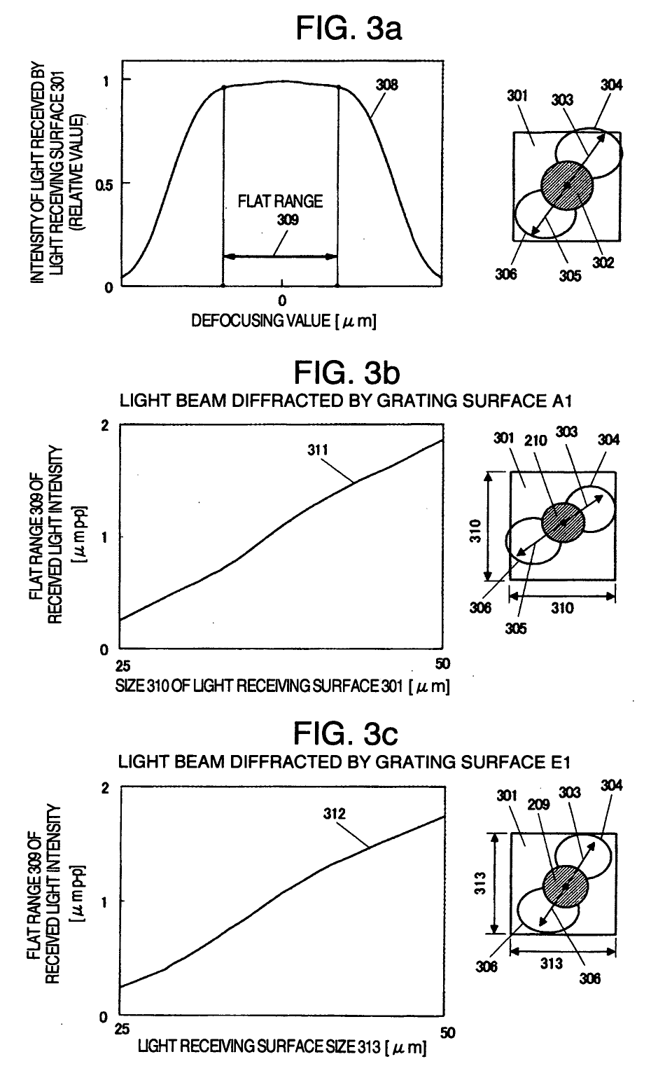

On the basis of the explanation on FIGS. 2a-2c, with making reference to FIGS. 3a-3c, a characteristic of the intensity of the light beam received by the light receiving surface 301 during the defocusing is explained. FIG. 3a shows at a right side view thereof the light beam 302 received by the light receiving surface 301 when the focusing is performed correctly and the light beam is 302 is diffracted by one of the grating surfaces A1-H1 of the optical beam multiple-dividing element 104, and having a diameter of about 25 μm as known from FIGS. 2a-2c. When a change of the light beam in accordance with a change from the correct focusing to the defocusing is calculated, the light beam 302 moves in a direction as shown by an arrow mark 303 to form a light beam 304 or moves in a direction as shown by an arrow mark 305 to form a light beam 306 so that the light beam moves in a direction away from a center of the light receiving surface 301. This is caused by that the light beam diffracted by one of the grating surfaces A1-H1 is a portion of a peripheral part of the light beam not-including a center of the light beam 208 as shown in FIG. 2c. In such situation, a characteristic curve 308 is obtained on a left side view of FIG. 3a whose abscissa axis corresponds to a value of the defocusing from the correct focusing and whose ordinate axis corresponds to an intensity (as a relative value with respect to the maximum intensity thereof imaginarily set at 1) of the light received by the light receiving surface 301. The intensity of the light received by the light receiving surface 301 is even in a range of the value of the defocusing denoted by an arrow mark 309, and decreases abruptly at an outside of the range of the value of the defocusing denoted by the arrow mark 309. For keeping a signal obtained from the light receiving surface 301 stable against the defocusing, it is preferable for the range of the value of the defocusing denoted by the arrow mark 309 where the intensity of the light received by the light receiving surface is even to be as wide as possible. Therefore, it is important for a relationship between a size of the light receiving surface and the flat range 309 to be acknowledged.

Therefore, it has been calculated how the relationship between the defocusing value from the correct focusing and the light receiving intensity of the light receiving surface 301 varies depending on a size 310 of the light receiving surface 301. A view on the left side of FIG. 3b is a graph about a light beam diffracted by the grating surface A1 whose abscissa axis corresponds to the size 310 of the light receiving surface 301 and whose ordinate axis corresponds to the range in which the light receiving intensity of the light receiving surface 301 is flat (range of the arrow mark 309), showing a change along a characteristic curve 311. It is appreciated from this graph that the range 309 in which the light receiving intensity of the light receiving surface 301 is flat increases as the size 310 of the light receiving surface 301 increases. This embodiment assumes that the size 310 of the light receiving surface 301 is, for example, about 50 μm (about twice the diameter of about 25 μm of the light beam 210). In such a case, the flat range 309 of light receiving intensity becomes about 1.8 μm p-p. This is a value about three times the focal depth of about 0.56 μm p-p of BD and a signal stable against the defocusing is obtained from the light receiving surface 301. For the light beam diffracted by the grating surfaces B1 to D1 as well as the grating surface A1, the size 310 of the light receiving surface 301 is assumed to be, for example, about 50 μm (equivalent to about 2.5 times the diameter of about 25 μm of the light beam 210). In this case, the flat range 309 of light receiving intensity becomes about 1.8 μm p-p and a signal stable against the defocusing is obtained from the light receiving surface 301.

A view on the left side of FIG. 3c is a graph about the light beam diffracted by the grating surface E1 whose abscissa axis corresponds to a size 313 of the light receiving surface 301 and whose ordinate axis corresponds to the flat range of light receiving intensity of the light receiving surface 301 (range shown by the arrow mark 309), which changes as shown by a characteristic curve 312. It is appreciated from this graph that the flat range 309 of light receiving intensity of the light receiving surface 301 increases as the size 313 of the light receiving surface 301 increases. This embodiment assumes that the size 313 of the light receiving surface 301 is about 50 μm (about twice the diameter of about 25 μm of light beam 209). In such a case, the flat range 309 of light receiving intensity becomes about 1.8 μm p-p. This is a value about three times the focal depth of about 0.56 μm p-p of BD and a signal stable against the defocusing is obtained from the light receiving surface 301. For the light beam diffracted by the grating surfaces F1 to H1 as well as the grating surface E1, the size 313 of the light receiving surface 301 is assumed to be, for example, about 50 μm. In this case, the flat range 309 of light receiving intensity becomes about 1.8 μm p-p and a signal stable against the defocusing is obtained from the light receiving surface 301.

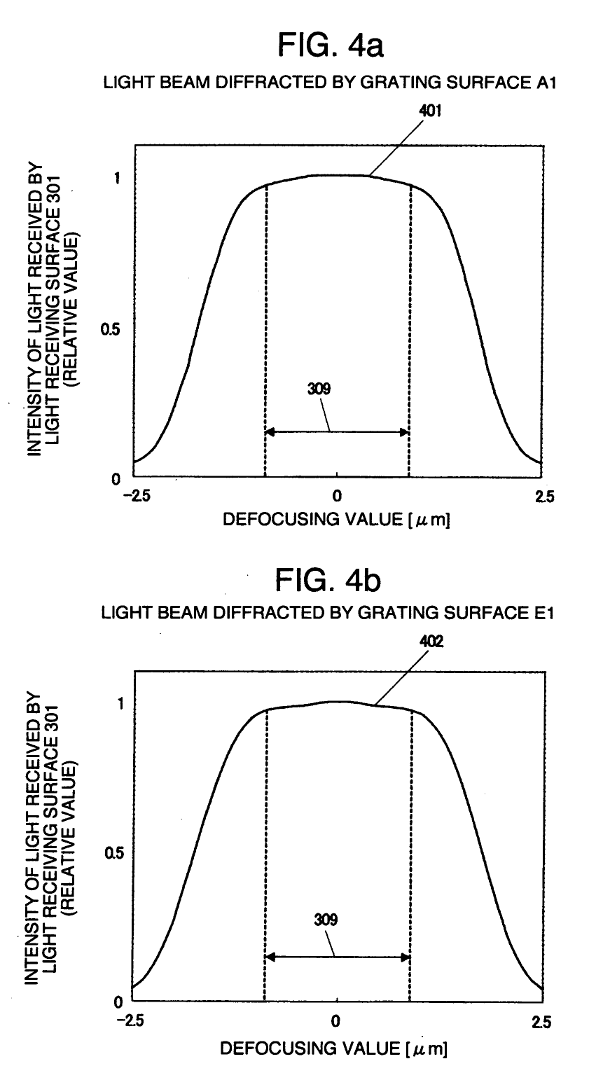

FIG. 4a shows an example of calculation on a defocusing value and an intensity of light received by the light receiving surface 301 (relative value) about the light beam diffracted by the grating surface A1 of the light beam multiple-dividing element 104 assuming that the size 310 of the light receiving surface 301 is about 50 μm set in FIG. 3. The flat range of a characteristic curve 401 obtained is as wide as about 1.8 μm p-p as shown by an arrow mark 309. FIG. 4b shows an example of calculation on a defocusing value and an intensity of light received by the light receiving surface 301 about the light beam diffracted by the grating surface E1 of the light beam multiple-dividing element 104 assuming that the size 313 of the light receiving surface 301 is about 50 μm set in FIG. 3. The flat range of a characteristic curve 402 obtained is as wide as about 1.8 μm p-p as shown by an arrow mark 309. When the light beam multiple-dividing element 104 is used, it is apparent from the above explanation what the relationship between the diameter of light beam irradiated onto the light receiving surface and the size of the light receiving surface should be like to obtain a signal stable against the defocusing from the light receiving surface 301.

FIG. 5 shows a light receiving surface pattern of the light receiving portion 112 of the BD optical sensor 109 determined based on the content explained with reference to FIGS. 2 to 4 above. Reference numeral 501 denotes a first imaginary central axis which corresponds to the radial direction of the information recording medium and substantially parallel to the radial direction of the information recording medium and 502 denotes a second imaginary central axis perpendicular to the first imaginary central axis 501. Reference numeral 509 shown by a hatched circle and denotes a light beam irradiated onto each light receiving surface when focus is achieved. A first light receiving surface 503 (marked with symbols A, B, C, D) divided into four pentagonal regions is provided on one side with respect to the first imaginary central axis 501 (−Y direction in the figure) and a second light receiving surface 504 (marked with symbols E, F, G, H) divided into hexagonal regions outside the first light receiving surface 503 (positions away from the imaginary central axis 501) is provided and a third light receiving surface 505 (marked with symbols I, J) divided into hexagonal regions outside the second light receiving surface 504 (positions away from the imaginary central axis 501) is provided. Furthermore, a fourth light receiving surface 506 (marked with symbols M, N, O, P) divided into two rectangular regions and two trapezoidal regions and a fifth light receiving surface 507 (marked with symbols S, Q, R, T) divided into hexagonal regions outside the fourth light receiving surface 506 (positions away from the imaginary central axis 501) are provided on the other side of the first imaginary central axis 501. Incidentally, the shapes of regions resulting from the division of the first light receiving surface 503 may also be four hexagons.

The first light receiving surface 503 (A to D), second light receiving surface 504 (E to H), third light receiving surface 505 (I, J), fourth light receiving surface 506 (M to P) and fifth light receiving surface 507 (Q to T) are arranged axisymmetrically with respect to the second imaginary central axis 502. Furthermore, the substantially central position of the first light receiving surface 503 and the substantially central position of the fourth light receiving surface 506 are arranged axisymmetrically with respect to the first imaginary central axis 501. In the same figure, the distance from the first imaginary central axis 501 to a single-dot dashed line 514 which is the substantially central position of the first light receiving surface 503 and the distance from the first imaginary central axis 501 to a single-dot dashed line 515 which is the substantially central position of the fourth light receiving surface 506 are set to the same value Y1. Furthermore, the substantially central position of the second light receiving surface 504 and the substantially central position of the fifth light receiving surface 507 are arranged axisymmetrically with respect to the first imaginary central axis 501. In the same figure, the distance from the first imaginary central axis 501 to a single-dot dashed line 516 which is the substantially central position of the second light receiving surface 504 and the distance from the first imaginary central axis 501 to a single-dot dashed line 517 which is the substantially central position of the fifth light receiving surface 507 are set to the same value Y2.

When light is focused on the information recording surface of the information recording medium, the fourth light receiving surface 506 is designed such that four light beams 509 are irradiated by the light beam multiple-dividing element 104 onto dark line portions 508 which constitute boundaries between M and O, N, and between P and O, N. A focusing error signal (FES) is generated from these four light beams using a double knife-edge method. Here, in FIG. 5, suppose a light intensity on each light receiving surface marked with symbols A to I is expressed with the same symbol. Incidentally, the way in which a light beam is irradiated from each grating surface of the light beam multiple-dividing element 104 will be explained later using FIG. 8.

The calculation formula of the focusing error signal (FES) is expressed by [Formula 2] shown below.

FES=(M+P)−(O+N) [Formula 2]

The tracking error signal (TES) is generated as will be explained below. First, a main tracking error signal (MTES) is generated from a plurality of light beams irradiated onto the first light receiving surface 503 (A to D) and the second light receiving surface 504 (E to H) and the calculation formula is expressed by [Formula 3] shown below.

MTES={(A+E)+(B+F)}−{(D+H)+(C+G)} [Formula 3]

Furthermore, a sub-tracking error signal (STES) is generated by a plurality of light beams irradiated onto the fifth light receiving surface 507 (Q to T) and the calculation formula is expressed by [Formula 4] shown below.

STES={(Q+R)−(S+T)} [Formula 4]

A tracking error signal (TES) is generated from a differential calculation between the MTES and STES and the calculation formula is expressed by [Formula 5] shown below.

TES=MTES−k×STES [Formula 5]

Here, k in [Formula 5] is a coefficient set so that a DC offset of TES expressed by [Formula 5] is compensated best when the BD objective lens 108 shown in FIG. 1 performs a tracking operation (moving in Y, −Y direction in FIG. 1). In the case of this embodiment, this k is set between about 2.4 to 2.7.

A reproducing signal (RF) is generated by a plurality of light beams irradiated onto the first light receiving surface 503 (A to D), the second light receiving surface 504 (E to H) and the third light receiving surface 505 (I, J), and the calculation formula thereof is expressed by [Formula 6] shown below.

RF=A+B+C+D+E+F+G+H+I+J [Formula 6]

A position signal (LE) of the objective lens 108 in the radial direction (Y, −Y direction in FIG. 1) of the information recording medium is generated by a plurality of light beams irradiated onto the fifth light receiving surface 507 (Q to T) and the calculation formula thereof is expressed by [Formula 7] shown below.

LE=(Q+R)−(S+T) [Formula 7]

As explained above with reference to FIG. 2, FIG. 3 and FIG. 4, suppose size S1 in X direction of the first light receiving surface 503 (A to D) is about 50 μm, size T1 in Y direction is about 50 μm, size S2 in X direction of the second light receiving surface 504 (E to H) is about 50 μm, size T2 in Y direction is about 50 μm, size S3 in X direction of the third light receiving surface 505 (I, J) is about 50 μm, size T3 in Y direction is about 50 μm, size S5 in X direction of the fifth light receiving surface 507 (Q to T) is about 50 μm, and size T5 in Y direction is about 50 μm. These sizes are equivalent to about 2.5 times the diameter of the light beam 509 irradiated onto each light receiving surface when focus is achieved.

As described above, signals obtained from a plurality of light beams irradiated onto the first light receiving surface 503, second light receiving surface 504, third light receiving surface 505 and fifth light receiving surface 507 are stable against the defocusing, that is, signals resistant to the defocusing are obtained, and it is thereby possible to obtain an effect of enabling the tracking error signal (TES) expressed by [Formula 3] to [Formula 5] above to have a characteristic stable against the defocusing.

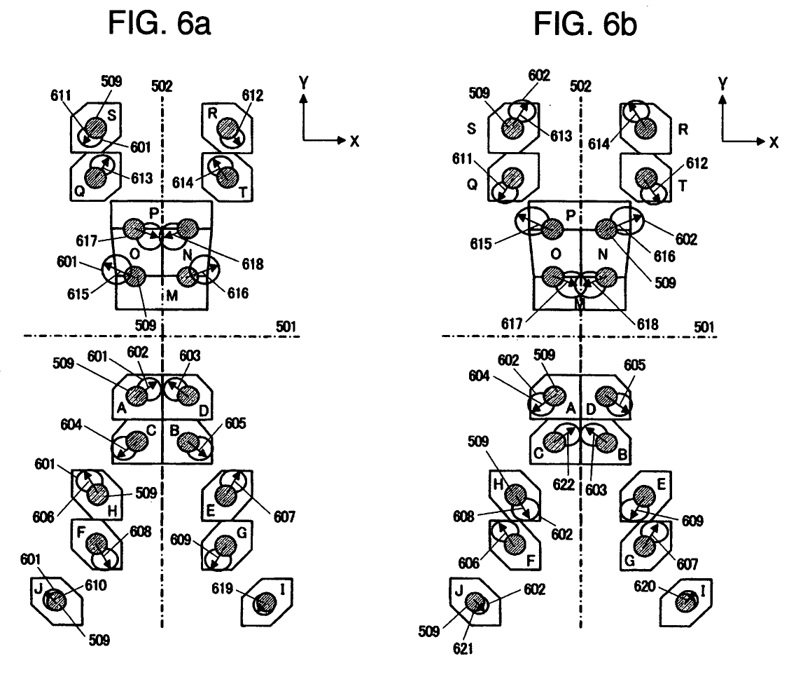

FIG. 6 schematically shows, when a light beam focused on the recording layer of the information recording medium is changed from the correct focusing to the defocusing, the results of calculations of variations of light spots irradiated onto the light receiving surfaces 503, 504, 505, 506, 507 of the optical sensor 109 explained using FIG. 5. FIG. 6a shows a case where the light beam is changed from the correct focusing is to the defocusing in −Z direction in FIG. 1 and FIG. 6b shows a case where the light beam is changed from the correct focusing to the defocusing +Z direction in FIG. 1. In FIG. 6a, the light beam 509 irradiated onto each light receiving surface moves in the direction shown by an arrow mark 602 in A, in the direction shown by an arrow mark 603 in D, in the direction shown by an arrow mark 604 in C, and in the direction shown by an arrow mark 605 in B and changes to a light beam 601 shown by a solid line. The light beam 509 moves in the direction shown by an arrow mark 606 in H, in the direction shown by an arrow mark 607 in E, in the direction shown by an arrow mark 608 in F, in the direction shown by an arrow mark 609 in G, in the direction shown by an arrow mark 619 in I, and in the direction shown by an arrow mark 610 in J and changes to the light beam 601 shown by a solid line. The light beam 509 moves in the direction shown by an arrow mark 611 in S, in the direction shown by an arrow mark 612 in R, in the direction shown by an arrow mark 613 in Q, and in the direction shown by an arrow mark 614 in T and changes to a light beam 601 shown by a solid line. The light beam 509 irradiated onto the dark line portion 508 which is a boundary between M and O moves in the direction shown by an arrow mark 615, the light beam 509 irradiated onto the dark line portion 508 which is a boundary between M and N moves in the direction shown by an arrow mark 616, the light beam 509 irradiated onto the dark line portion 508 which is a boundary between O and P moves in the direction shown by an arrow mark 617, the light beam 509 irradiated onto the dark line portion 508 which is a boundary between N and P moves in the direction shown by an arrow mark 618, and changes to a light beam 601 shown by a solid line. In FIG. 6b, the light beam 509 irradiated onto each light receiving surface in the correct focusing moves in the direction shown by an arrow mark 604 in A, in the direction shown by an arrow mark 605 in D, in the direction shown by an arrow mark 622 in C, and in the direction shown by an arrow mark 603 in B, and changes to a light beam 602 shown by a solid line. The light beam 509 moves in the direction shown by an arrow mark 608 in H, in the direction shown by an arrow mark 609 in E, in the direction shown by an arrow mark 606 in F, in the direction shown by an arrow mark 607 in G, in the direction shown by an arrow mark 620 in I, and in the direction shown by an arrow mark 621 in J, and changes to a light beam 602 shown by a solid line. The light beam 509 moves in the direction shown by an arrow mark 613 in S, in the direction shown by an arrow mark 614 in R, in the direction shown by an arrow mark 611 in Q, in the direction shown by an arrow mark 612 in T, and changes to a light beam 602 shown by a solid line. The light beam 509 irradiated onto the dark line portion 508 which is a boundary between M and moves in the direction shown by an arrow mark 617, the light beam 509 irradiated onto the dark line portion 508 which is a boundary between M and N moves in the direction shown by an arrow mark 618, the light beam 509 irradiated onto the dark line portion 508 which is a boundary between O and P moves in the direction shown by an arrow mark 615, and the light beam 509 irradiated onto the dark line portion 508 which is a boundary between N and P moves in the direction shown by an arrow mark 616, and changes to a light beam 602 shown by a solid line. As shown in FIG. 6, the angle by which the light beam 509 moves increases as the light beam goes away from the imaginary central axis 501.

Summing up the above described results, it is appreciated that when the focusing is changed to the defocusing, the track of the light beam 509 on each light receiving surface is any one of the rightward rising/falling directions or leftward rising/falling directions with respect to the surface of the sheet. Therefore, the shape of each light receiving surface need not be rectangular and portions other than the track of the light beam 509 become unnecessary. For this reason, each light receiving surface 503, 504, 505 or 507 in FIG. 5 is divided into pentagonal or hexagonal regions. That is, the shape for obtaining a signal stable against the defocusing and having a necessary minimum region is adopted. This produces effects of suppressing a total area of light receiving surface divided into a many portions to a minimum necessary area and suppressing drastic deterioration of the electric frequency characteristic of the optical sensor 109.

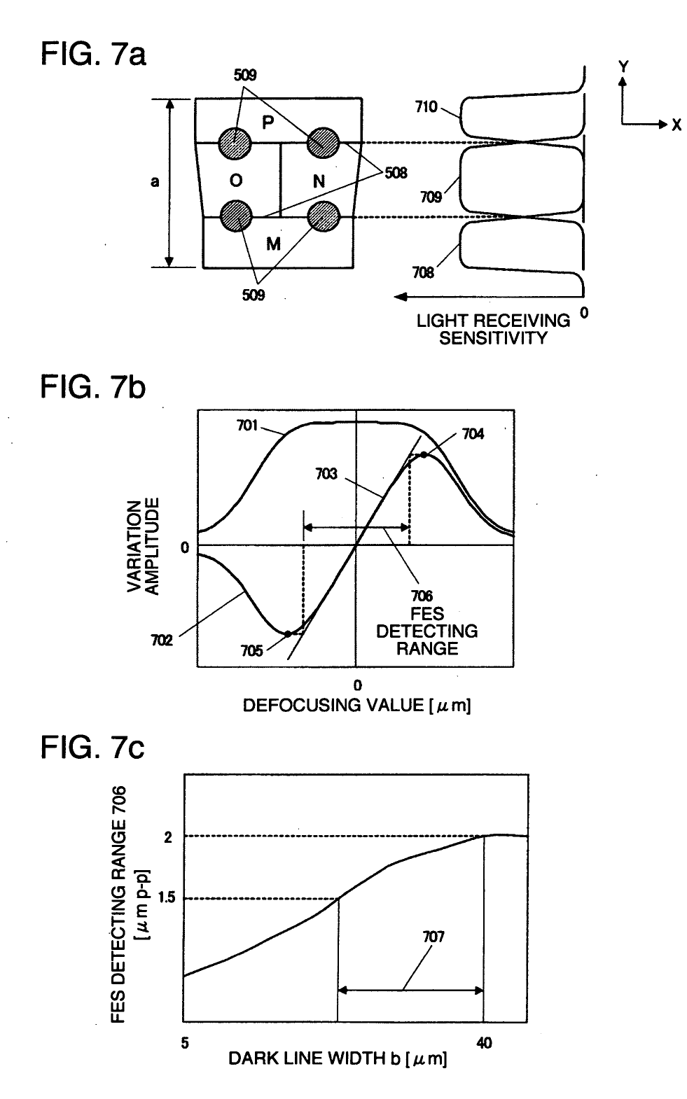

The fourth light receiving surface 506 which detects the above described focusing error signal (FES) will be explained using FIG. 7. In FIG. 7a, reference numeral 509 denotes a light beam irradiated onto the dark line portion 508 where a light beam focused on the recording layer of the information recording medium is in the correct focusing. A view on the right side of FIG. 7a schematically shows light receiving sensitivity at M, N, O and P. The dark line portion 508 is a region where the light receiving sensitivity decreases continuously and the light receiving sensitivity varies continuously as shown by a solid line 708 in M, as shown by a solid line 709 in O and N and as shown by a solid line 710 in P. The size in Y direction of the fourth light receiving surface 506 is denoted as “a” and the size in Y direction of the dark line portion 508 is denoted as “b.” An example of calculating a relationship between the b size of the dark line portion 508 (dark line width b) and the FES detecting range will be explained using FIG. 7b and FIG. 7c. Note that the size a is fixed.

FIG. 7b shows a graph whose abscissa axis corresponds to a defocusing value and whose ordinate axis corresponds to a FES amplitude and an amplitude of sum signal detected from the light receiving intensities of four light beams 509. Reference numeral 701 denotes the amplitude waveform of sum signal, 702 denotes an amplitude waveform of FES, and a FES detecting range 706 is defined as a distance shown by an arrow mark 706 between a point of intersection between a dotted line drawn in horizontal direction from a maximum value 704 of the amplitude waveform 702 of FES and a tangent 703 drawn along the amplitude waveform 702 of FES centered on a defocusing value 0 and a point of intersection between a dotted line drawn from a minimum value 705 of the amplitude waveform 702 of FES in horizontal direction and the tangent 703.

FIG. 7c shows an example of calculating a relationship between the b size of dark line portion 508 (described as dark line width b on the abscissa axis in the figure) and FES detecting range 706 and there is a relationship that the FES detecting range 706 increases as the b size of dark line portion 508 increases. About 1.5 to 2 μm p-p is an appropriate value as the FES detecting range 706 for BD and this embodiment obtains an appropriate FES detecting range of 1.5 to 2 μm p-p by setting the b size of dark line portion 508 to about 25 to 40 μm. The b size of dark line portion 508 corresponds to a range about 1 to 1.6 times of the diameter of about 25 μm of the light beam 509.

The light beam multiple-dividing element 104 will be explained using FIG. 8. FIG. 8a shows a grating pattern formed in the light beam multiple-dividing element 104. The light beam multiple-dividing element 104 is composed of a plurality of polarizing grating surfaces A1 to L1, a dotted line 114 shows the diameter of light beam at the position of the light beam multiple-dividing element 104 and two regions 811 enclosed by two-dot dashed line 810 and dotted line 114 (hatched region) show push-pull regions where zero-order light and ±primary light reflected and diffracted by tracks of the information recording medium overlap each other.

The light beam multiple-dividing element 104 is divided by a first imaginary line 801 (X direction in the figure) substantially parallel to a line crossing the two push-pull regions 811 and a second imaginary line 802 (Y direction in the figure) perpendicular to the first imaginary line and is provided with a first grating region made up of four polarizing grating surfaces I1, J1, K1, L1 divided symmetrically about a point of intersection 812 at which the first imaginary line 801 and the second imaginary line 802 cross each other, a second grating region made up of four polarizing grating surfaces A1, B1, C1, D1 divided symmetrically about the point of intersection 812 provided outside the first grating region and a third grating region made up of four polarizing grating surfaces E1, F1, G1, H1 divided symmetrically about the point of intersection 812 provided outside the first grating region. The light beam multiple-dividing element 104 is an element in which the polarizing grating surfaces A1 to L1 and a quarter wave length plate (not shown) are integrated into one body. Reference character U in FIG. 8a denotes the size (width) in X direction of the first grating region, V denotes the size (height) in Y direction of the first grating region (I1 to L1), W denotes the size (height) in Y direction of the second grating region (A1 to D1) and D denotes the diameter of the light beam at the position of the polarizing grating surface of the light beam multiple-dividing element 104. This embodiment sets the value of U/D to a range of about 40 to 44%, the value of V/D to a range of about 40 to 44% and the value of W/D to a range of about 56 to 58%.

FIG. 8b is a diagram illustrating a light beam on the polarizing grating surfaces A1 to H1. A light beam 803 which is linearly polarized light (P polarized light) emitted from the laser beam source 101 proceeds without being diffracted in the region of the polarizing grating surface of the light beam multiple-dividing element 104, is converted to circularly polarized light, that is, a light beam 804 in the region of the quarter wave length plate (not shown), focused by the BD objective lens 108 and irradiated onto an information recording surface 809 of an information recording medium 808. A light beam 805 which is reflected by the information recording surface 809 and passes through the BD objective lens 108 is converted to linearly polarized light (S polarized light) perpendicular to linearly polarized light (P polarized light) emitted from the laser beam source 101 in the region of the quarter wave length plate (not shown) of the light beam multiple-dividing element 104 and diffracted to −primary light 807 and +primary light 806 in a region of the polarizing grating surface. In this case, no zero-order light is generated.

FIG. 8c is a diagram illustrating a light beam on the polarizing grating surfaces I1 to L1. A light beam 803 which is linearly polarized light (P polarized light) emitted from the laser beam source 101 proceeds without being diffracted in the region of the polarizing grating surface of the light beam multiple-dividing element 104, converted to a light beam 804 which is circularly polarized light in the region of a quarter wave length plate (not shown), focused by the BD objective lens 108 and irradiated onto the information recording surface 809 of the information recording medium 808. A light beam 805 which is reflected by the information recording surface 809 and proceeds through the BD objective lens 108 is converted to linearly polarized light (S polarized light) perpendicular to the linearly polarized light (P polarized light) emitted from the laser beam source 101 in the region of the quarter wave length plate of the light beam multiple-dividing element 104, and diffracted to only +primary light 806 in the region of the polarizing grating surface. That is, the light beam multiple-dividing element 104 is formed such that the intensity of +primary light is greater than the intensity of −primary light, but in this case neither −primary light nor zero-order light is generated. Such a grating surface of the light beam multiple-dividing element 104 can be formed through blazing. Table 1 shows grating pitches and grating angles in the polarizing grating surfaces A1 to L1 in this embodiment.

TABLE 1

| Grating area | Grating pitch | Grating angle |
|---|---|---|
| A1 | d1 | −θ 1 |
| B1 | d2 | +θ 2 |
| C1 | d2 | −θ 2 |
| D1 | d1 | +θ 1 |
| E1 | d3 | +θ 3 |
| F1 | d4 | −θ 1 |
| G1 | d4 | +θ 1 |
| H1 | d3 | −θ 3 |
| I1 | d5 | +θ 4 |
| J1 | d5 | −θ 4 |
| K1 | d5 | +θ 4 |
| L1 | d5 | −θ 4 |

where,
d1 > d2 > d3 > d4 > d5
θ 4 > θ 3 > θ 1 > θ 2

The grating pitches and grating angles in the polarizing grating surfaces A1 to L1 are set as shown in Table 1. The grating surfaces A1 and D1 have the same grating pitch of d1 and grating angles of θ1 in opposite directions. The grating surfaces B1 and C1 have the same grating pitch of d2 and grating angles of θ2 in opposite directions. The grating surface E1 and H1 have the same grating pitch of d3 and grating angles of θ3 in opposite directions. The grating surfaces F1 and G1 have the same grating pitch of d4 and grating angles of θ1 in opposite directions. The grating surfaces I1 and J1 have the same grating pitch of d5 and grating angles of θ4 in opposite directions. The grating surfaces K1 and L1 have the same grating pitch of d5 and grating angles of θ4 in opposite directions. Here, a relationship of d1>d2>d3>d4>d5 is provided for the grating pitches and a relationship of θ4>θ3>θ1>θ2 is provided for the grating angles.

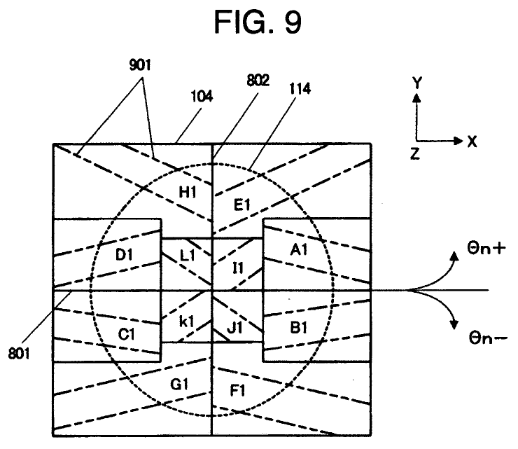

FIG. 9 schematically shows grating grooves 901 (shown by two-dot dashed lines) having the grating angles described in Table 1 formed in the respective grating surfaces of the light beam multiple-dividing element 104. Furthermore, the definitions of sign and direction of grating angle θn (n=1 to 4) are also described.

Here, an explanation will be given about onto which light receiving surface of the light receiving portion 112 of the optical sensor 109 explained using FIG. 5, the light beam diffracted by the grating surface in each region of the light beam multiple-dividing element 104 explained using FIG. 8, FIG. 9 and Table 1 is irradiated. The +primary light 806 diffracted by the four grating surfaces (A1 to D1) in the second grating region is irradiated onto the first light receiving surfaces 503 (A to D) of the optical sensor 109 and the −primary light 807 diffracted by the four grating surfaces (A1 to D1) in the second grating region is irradiated onto the dark line portion 508 or M to P of the fourth light receiving surface 506. The +primary light 806 diffracted by the four grating surfaces (E1 to H1) in the third grating region enters the second light receiving surfaces (E to H), and the −primary light 807 diffracted by the four grating surfaces (E1 to H1) in the third grating region enters the fifth light receiving surfaces 507 (Q to T). The +primary light 806 diffracted by the four grating surfaces (I1 to L1) in the first grating region is irradiated onto the third light receiving surfaces 505 (I, J). In this way, a plurality of light beams are irradiated and signals expressed by [Formula 2] to [Formula 7] above are obtained.

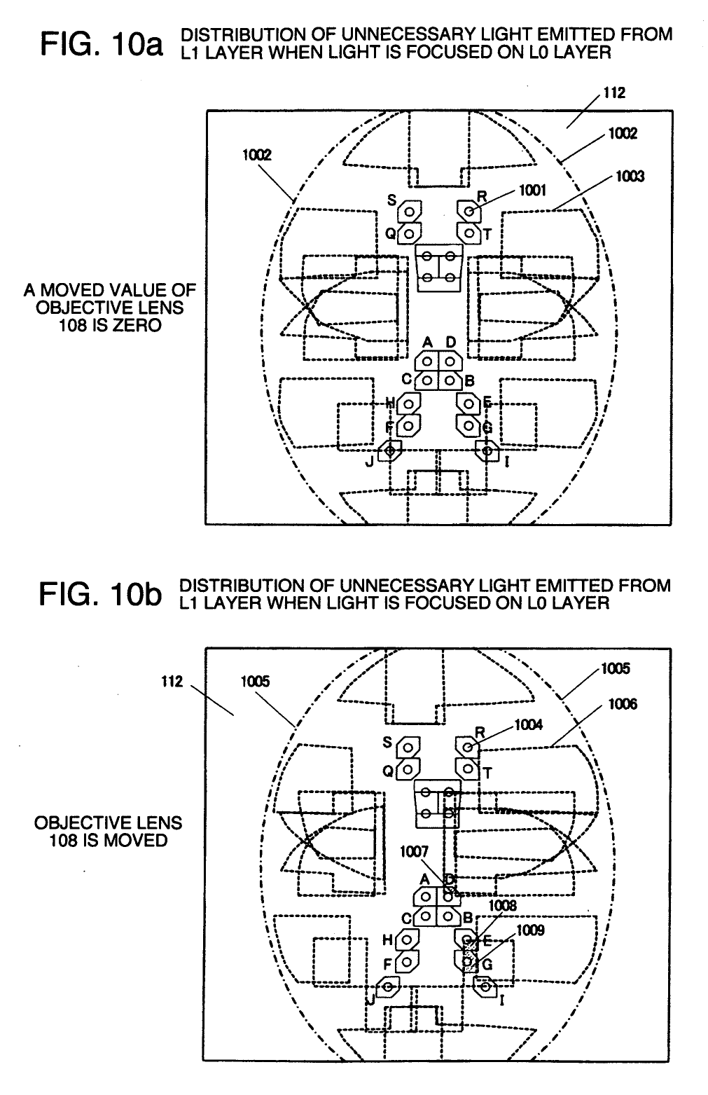

FIG. 10 shows a BD information recording medium having two data layers of an L0 layer (cover layer having a thickness of about 100 μm) and an L1 layer (cover layer having a thickness of about 75 μm) and an example of calculating, when light is focused on the target L0 layer, a distribution of unnecessary light reflected from the L1 layer which is a non-target layer and irradiated onto the light receiving portion 112 of the optical sensor 109. FIG. 10a shows a case where a value of movement of the BD objective lens 108 shown in FIG. 1 in the Y direction (radial direction of BD information recording medium) is 0. A plurality of circles 1001 denote light beams reflected by the above described L0 layer and focused by a detecting lens and each signal expressed by [Formula 2] to [Formula 7] above is generated in accordance with the intensity of light irradiated onto each light receiving surface. A region enclosed by a dotted line 1003 shows the above described unnecessary light, which is divided into multiple portions by the above described light beam multiple-dividing element 104. Therefore, a region denoted by a single-dot dashed line 1002 where no unnecessary light exists is generated in the outermost circumference of the region irradiated with the unnecessary light enclosed by the dotted line 1003. The first light receiving surface 503, second light receiving surface 504, fourth light receiving surface 506 and fifth light receiving surface 507 shown above in FIG. 5 are arranged in this region where no unnecessary light exists. FIG. 10b shows a case where the BD objective lens 108 shown in FIG. 1 has moved in the Y direction (radial direction of the BD information recording medium). A circle 1004 denotes a light beam reflected by the L0 layer and focused by the detecting lens and a region enclosed by a dotted line 1006 denotes the above described unnecessary light. The irradiation condition of the unnecessary light changes from the condition shown in FIG. 10a and the unnecessary light is irradiated onto part of P, E and G as shown by hatched regions 1007, 1008 and 1009. However, the intensity of the unnecessary light is small enough with respect to the light intensity of the light beam 1004 which is the signal light and the main tracking error signal (MTES) shown above by [Formula 3] is obtained by a calculation formula of MTES={(A+E)+(B+F)−{(D+H)+(C+G)}, and therefore intensities of light received by E and G have a relationship of being subtracting from each other and the MTES is never disturbed. Furthermore, no unnecessary light is irradiated onto the fifth light receiving surface 507 (Q, R, S, T). Since the sub-tracking error signal (STES) expressed above by [Formula 4] is obtained by a calculation formula of STES={(Q+R)−(S+T)}, the STES receives no influence from the unnecessary light. Therefore, the STES can generate only a DC offset component necessary to compensate a DC offset generated by the MTES when the BD objective lens 108 performs a tracking operation without any disturbance. As described above, since the tracking error signal (TES) expressed by [Formula 5] is obtained by a calculation formula of TES=MTES−k×STES, the TES is never disturbed and it is possible to obtain a stable tracking error signal (TES) less subject to unnecessary light from other layers even when the BD objective lens 108 performs a tracking operation. Furthermore, the position signal (LE) of the BD objective lens 108 in the tracking direction (Y, −Y direction in FIG. 1) expressed by [Formula 7] is obtained by a calculation formula of LE=(Q+R)−(S+T), and therefore the LE is never disturbed and it is possible to obtain a stable position signal of the objective lens less subject to unnecessary light form other layers. The unnecessary light is irradiated onto I and J, but since these regions are used only to detect the reproducing signal (RF) expressed above by [Formula 6], irradiation of the unnecessary light constitutes no practical problem.

The state in which the unnecessary light reflected by the L1 layer has not been irradiated onto Q, R, S, T at all is the effect resulting from the fact that the value of U/D is set to about 40 to 44% and the value of V/D is set to about 40 to 44% for the sizes U and V of the first grating region made up of the four polarizing grating surfaces I1 to L1 as shown in FIG. 8a, and the multiple-dividing element 104 is formed such that only +primary light 806 is diffracted by the polarizing grating surfaces I1 to L1 as shown in FIG. 8c. Furthermore, only the +primary light 806 is made to be diffracted by the polarizing grating surfaces I1 to L1, and the intensity of light irradiated onto I and J can be intensified. Since the above described reproducing signal (RF) is obtained from the calculation formula RF=A+B+C+D+E+F+G+H+I+J as expressed above by [Formula 6], the signal intensity of the reproducing signal (RF) can be intensified and there is an effect that a reproducing signal having a good S/N characteristic is obtained. The reason that only the +primary light 806 is diffracted in the first grating region made up of the four polarizing grating surfaces I1 to L1 of the multiple-dividing element 104 is as follows. If even −primary light is also made to be generated on the polarizing grating surfaces I1 to L1, unnecessary light (not shown) generated from the polarizing grating surfaces I1 to L1 is irradiated onto the fifth light receiving surface 507 (Q, R, S, T) and therefore there are influences by unnecessary light from other layers, the sub-tracking error signal (STES) is disturbed and no more stable tracking error signal (TES) can be obtained. Furthermore, since the −primary light diffracted by the polarizing grating surfaces I1 to L1 do not enter any light receiving surface, the intensity of the reproducing signal (RF) decreases and the S/N characteristic thereof deteriorates.

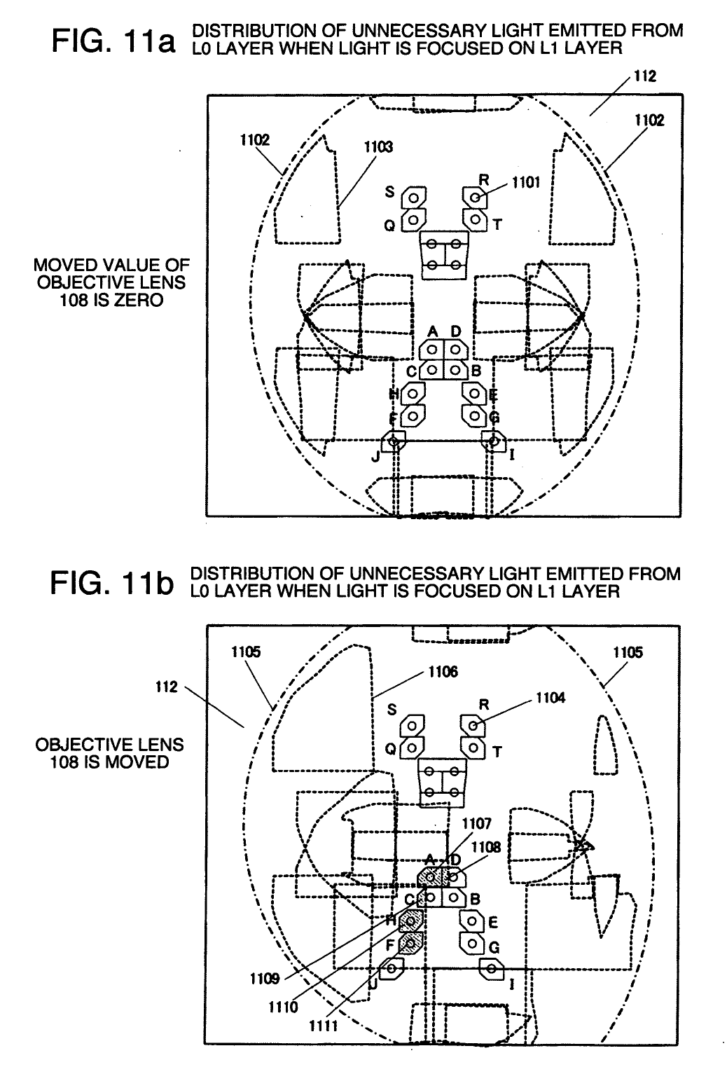

FIG. 11 shows a BD information recording medium having two data layers of an L0 layer (cover layer having a thickness of about 100 μm) and an L1 layer (cover layer having a thickness of about 75 μm) and an example of calculating, when light is focused on the target L1 layer, a distribution of unnecessary light reflected from the L0 layer which is a non-target layer and irradiated onto the light receiving portion 112 of the optical sensor 109. FIG. 11a shows a case where a value of movement of the BD objective lens 108 in the Y direction (radial direction of BD information recording medium) shown in FIG. 1 is 0. A plurality of circles 1101 denote light beams reflected by the L1 layer and focused by a detecting lens and each signal expressed by [Formula 2] to [Formula 7] above in accordance with the intensity of light irradiated onto each light receiving surface. A region enclosed by a dotted line 1103 denotes the above described unnecessary light, which is divided into multiple portions by the light beam multiple-dividing element 104. Therefore, a region denoted by a single-dot dashed line 1102 where no unnecessary light exists is generated in the outermost circumference of the region irradiated with the unnecessary light enclosed by the dotted line 1103. The first light receiving surface 503, second light receiving surface 504, fourth light receiving surface 506 and fifth light receiving surface 507 shown above in FIG. 5 are arranged in this region where no unnecessary light exists.

FIG. 11b shows a case where the BD objective lens 108 shown in FIG. 1 has moved in the Y direction (radial direction of the BD information recording medium). A plurality of circles 1104 show light beams reflected by the L1 layer and focused by the detecting lens and the region enclosed by a dotted line 1106 denotes the unnecessary light. The irradiation condition of the unnecessary light changes from the condition shown in FIG. 11a and the unnecessary light is irradiated onto part of C, D and A, H and F as shown in hatched regions 1107, 1108, 1109, 1110 and 1111. However, the intensity of the unnecessary light is small enough with respect to the light intensity of the light beam 1104 which is the signal light and the main tracking error signal (MTES) shown above by [Formula 3] is obtained by a calculation formula of MTES={(A+E)+(B+F)−{(D+H)+(C+G)}, and therefore the intensities of light received by A and H, and F and (C+D) have a relationship of being subtracted from each other and the MTES is never disturbed. Furthermore, no unnecessary light is irradiated onto the fifth light receiving surface 507 (Q, R, S, T). Since the sub-tracking error signal (STES) expressed above by [Formula 4] is obtained by a calculation formula of STES={(Q+R)−(S+T)}, the STES receives no influence from the unnecessary light. Therefore, the STES can generate only the DC offset component necessary to compensate a DC offset generated by the MTES when the BD objective lens 108 performs a tracking operation without any disturbance. As described above, since the tracking error signal (TES) expressed by [Formula 5] is obtained by a calculation formula of TES=MTES−k×STES, the TES is never disturbed and it is possible to obtain a stable tracking error signal when the BD objective lens 108 performs a tracking operation. Here, the state in which the unnecessary light reflected by the L1 layer has not been irradiated onto Q, R, S, T at all is the effect resulting from the fact that the value of U/D is set to about 40 to 44% and the value of V/D is set to about 40 to 44% as shown in FIG. 8a and the multiple-dividing element 104 is formed such that only +primary light 806 is diffracted by the polarizing grating surfaces I1 to L1 as explained using FIG. 8c. It is appreciated from above that it is possible to obtain a stable tracking error signal (TES) and position signal (LE) of the objective lens 108 in the tracking direction (Y, −Y direction in FIG. 1) less subject to unnecessary light from other layers using the BD information recording medium having two layers of L0 layer (cover layer having a thickness of about 100 μm) and L1 layer (cover layer having a thickness of about 75 μm).

### Second Embodiment

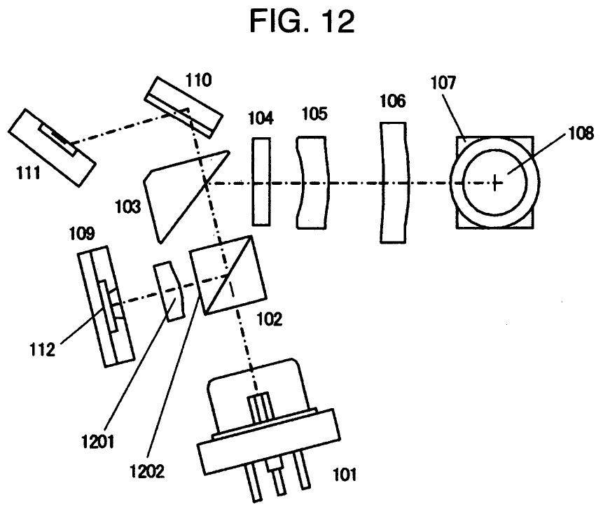

A second embodiment of the present invention will be explained using FIG. 12 to FIG. 15.

FIG. 12 is an upper view showing schematically an optical head for BD in this embodiment. The second embodiment differs from the first embodiment explained using FIG. 1 in that a focusing lens 1201 is arranged between a light exit surface 1202 of a polarized beam splitter 102 and a BD optical sensor 109. The other parts are the same as those in FIG. 1 and explanations thereof will be omitted here.

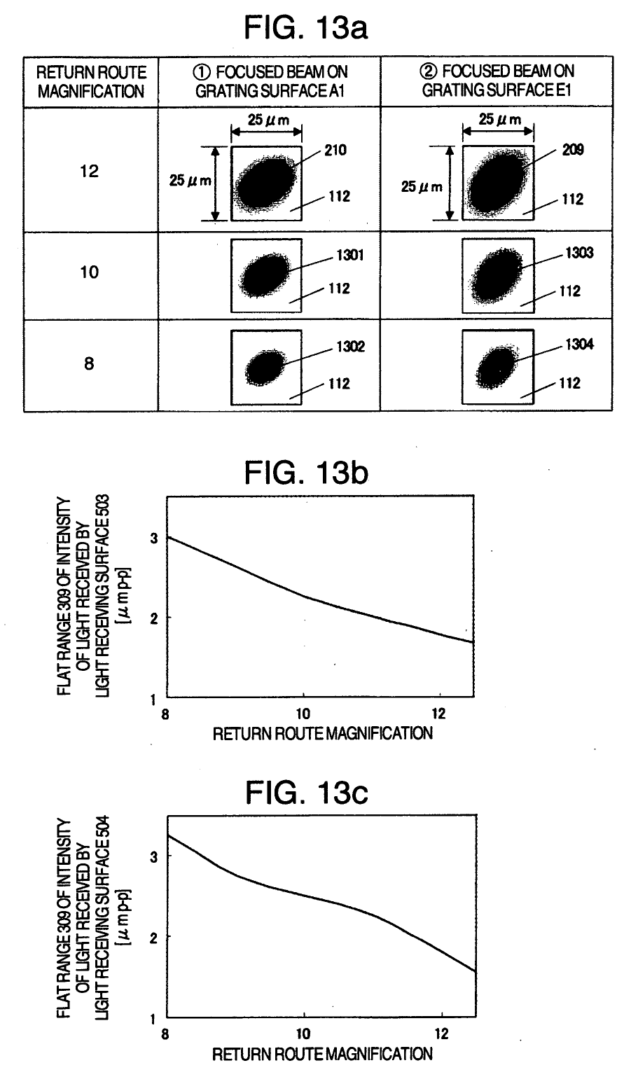

FIG. 13a shows the result of reducing a magnification of a return route which is an optical path from a BD data layer to the BD optical sensor 109 (synthetic focal distance of BD assistant lens 105, BD collimating lens 106 and focusing lens 1201÷focal distance of an objective lens 108) from about 12 times (=approach route magnification) to 10 times, 8 times that in the first embodiment and obtaining, through a diffraction optical calculation, an image of light beam diffracted by the grating surface A1 and grating surface E1 shown in FIG. 8a and focused on and irradiated onto a light receiving portion 112 of the optical sensor 109. (1) The image of light beam diffracted by the grating surface A1 changes as shown by reference numerals 210, 1301 and 1302 as the magnification of the return route is reduced from about 12 times to 10 times, 8 times and the diameter of light beam decreases. (2) The image of light beam diffracted by the grating surface E1 changes as shown by reference numerals 209, 1303 and 1304 as the magnification of the return route is reduced from about 12 times to 10 times, 8 times and the diameter of light beam decreases. Here, the light beam diffracted by the grating surface A1 and grating surface E1 has been explained as an example, but the diameters of light beams diffracted by other grating surfaces likewise decrease as the magnification of the return route is reduced.

FIG. 13b shows an example where the abscissa axis shows a return route magnification and the ordinate axis shows a calculated range 309 in which the intensity of light received by the first light receiving surfaces 503 (A to D) shown in FIG. 5 is flat. Here, the size of the light receiving surface in the light receiving portion 112 is about 50 μm set in the first embodiment. When the magnification of the return route is reduced from about 12 times (=approach route magnification) in the first embodiment, the above described flat range 309 increases. FIG. 13c shows an example where the abscissa axis shows a return route magnification and the ordinate axis shows the calculated range 309 in which the intensity of light received by the second light receiving surfaces 504 (E to H) is flat. Here, the size of the light receiving surface in the light receiving portion 112 is assumed to be about 50 μm set in the first embodiment. When, the magnification of the return route is reduced from about 12 times that of the first embodiment as in the case of FIG. 13b, the flat range 309 increases. As described above, by making the magnification (=about 12 times) of the return route smaller than the magnification of the approach route, the numerical aperture (NA) of the light beam on each grating surface shown in FIG. 8a increases compared with that of the first embodiment, and therefore the diameter of light beam of the light receiving surface decreases. Since the focusing lens 1201 is added to the first embodiment, the number of parts increases by one, but the range 309 in which the intensity of light received by the light receiving surface is flat increases, which produces an effect that the tracking error signal (TES) becomes more stable against the defocusing compared to the first embodiment. Furthermore, when the tracking error signal (TES) is set to the same defocusing characteristic as that of the first embodiment, the size of the light receiving surface can be reduced conversely, also producing an effect that the size of the optical sensor 109 can be reduced.

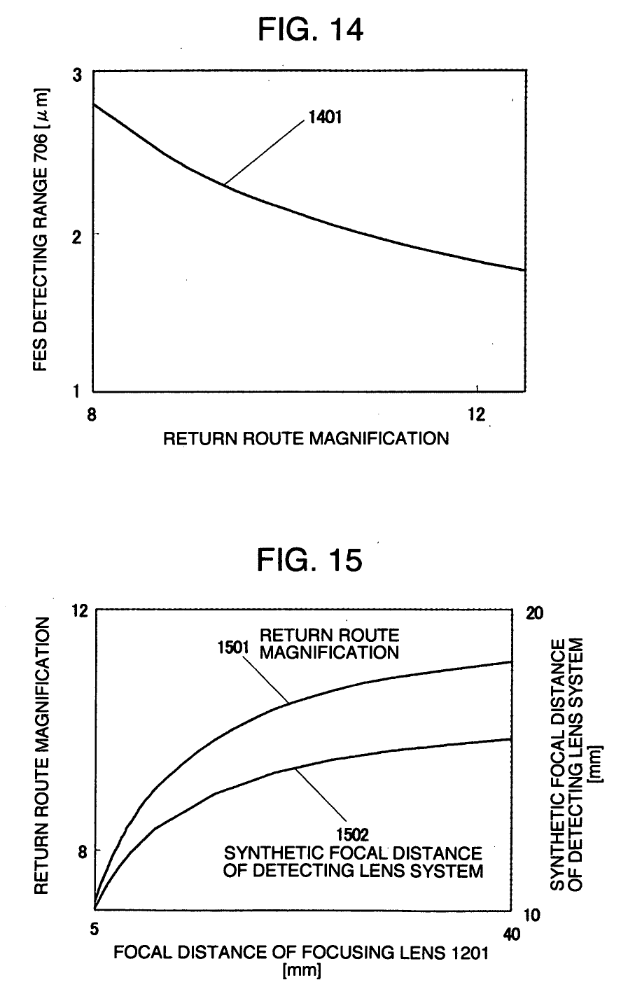

FIG. 14 shows an example where the dark line width b shown in FIG. 7a is set to about 30 μm and a relationship between the magnification of the return route and the detecting range 706 of the focusing error signal (FES) is calculated. The relationship is expressed by the characteristic curve shown by reference numeral 1401 and there is a relationship that the FES detecting range 706 increases as the magnification of the return route is reduced from about 12 times (=approach route magnification) that of the first embodiment. When, for example, the return route magnification is set to 9 to 10 times, it is possible, from FIGS. 13a and 13b, to set the range 309 in which the intensity of light received by the light receiving surface is flat as wide as about 2 to 2.6 μm and set the FES detecting range 706 to a practical range of about 2 to 2.4 μm. That is, there is an effect that a tracking error signal (TES) resistant to a defocusing characteristic and a focusing error signal (FES) having a practically appropriate FES detecting range can be obtained. The return route magnification may be changed from the range of 9 to 10 times the above described range depending on the desired specification. FIG. 15 shows a calculation example of a relationship between the focal distance and return route magnification of the focusing lens 1201 and the synthetic focal distance of the detecting lens system (106, 105, 1201). The characteristic curve of magnification of the return route becomes as shown by reference numeral 1501 and the characteristic curve of the synthetic focal distance of the detecting lens becomes as shown by 1502. When, for example, the return route magnification is set to 9 to 10 times, the focal distance of the focusing lens 1201 may be set to about 10 to 15 mm. The synthetic focal distance of the detecting lens system in this case is within a range of about 13 to 14 mm, which is a value smaller than about 17 mm of the synthetic focal distance of the collimating lens system in the approach route.

### Third Embodiment

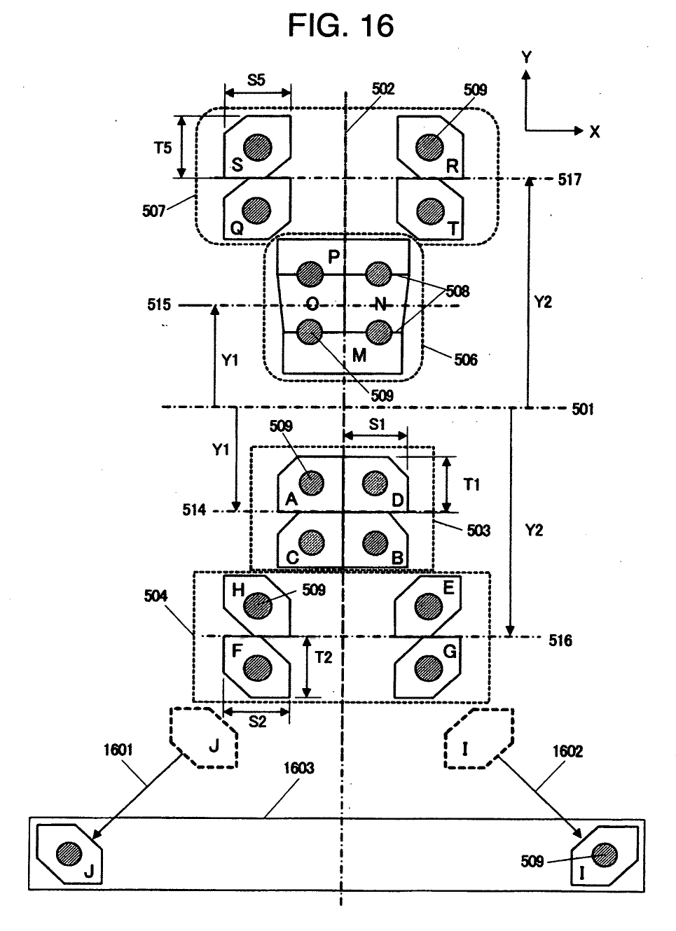

A third embodiment of the present invention will be explained using FIGS. 16 to 18. FIG. 16 shows a light receiving surface pattern of a light receiving portion 112 of a BD optical sensor 109 in this embodiment. This embodiment differs from the first embodiment in FIG. 5 in that a third light receiving surface 1603 is formed by moving I away in the direction shown by an arrow mark 1602 and moving J away in the direction shown by an arrow mark 1601. Incidentally, I and J shown with dotted lines indicate the positions of the first embodiment in FIG. 5. Since the other parts are the same as those in FIG. 5, explanations thereof will be omitted here.

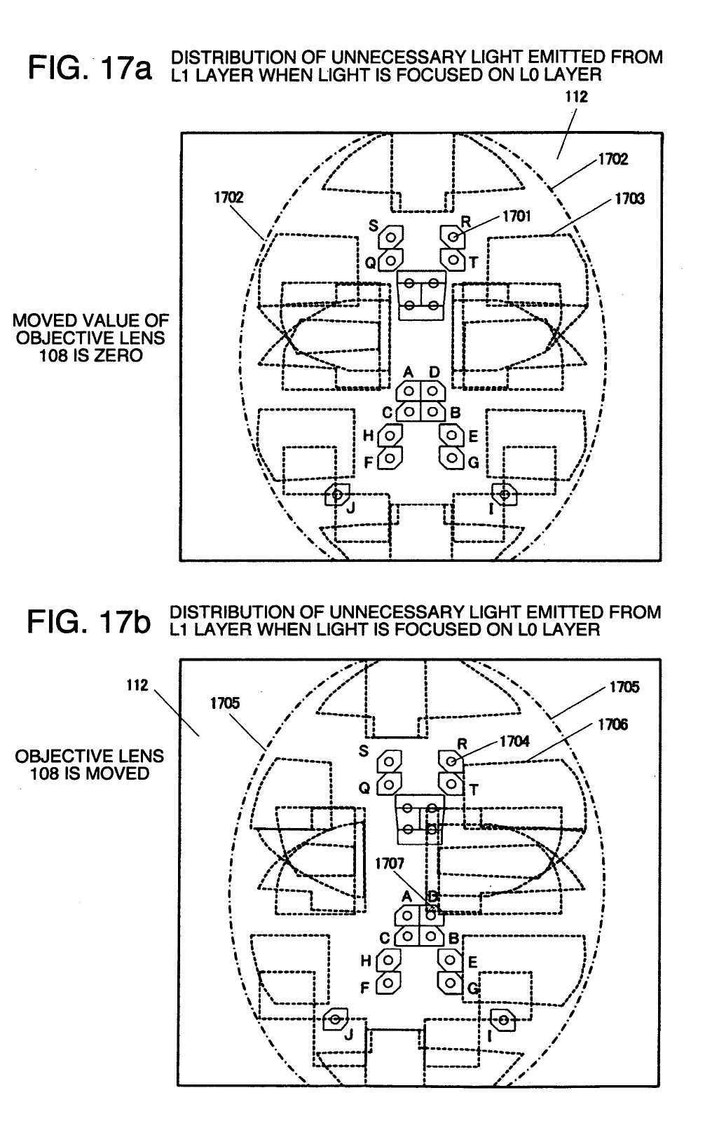

FIG. 17 shows a BD information recording medium having two data layers of an L0 layer (cover layer having a thickness of about 100 μm) and an L1 layer (cover layer having a thickness of about 75 μm) and an example of calculating, when light is focused on the target L0 layer, a distribution of unnecessary light reflected from the L1 layer which is a non-target layer and irradiated onto the light receiving portion 112 of the optical sensor 109. FIG. 17a shows a case where a value of movement of the objective lens 108 shown in FIG. 1 in the Y direction (radial direction of the BD information recording medium) is 0. A plurality of circles 1701 denote light beams reflected from the L0 layer and focused by a detecting lens and each signal expressed by [Formula 2] to [Formula 7] above is generated in accordance with the intensity of light irradiated onto each light receiving surface. A region enclosed by a dotted line 1703 denotes unnecessary light, which is divided into multiple portions by the light beam multiple-dividing element 104. Therefore, a region denoted by a single-dot dashed line 1702 where no unnecessary light exists is generated in the outermost circumference of the region irradiated with the unnecessary light enclosed by the dotted line 1703. The first light receiving surface 503, second light receiving surface 504, fourth light receiving surface 506 and fifth light receiving surface 507 shown above in FIG. 16 are arranged in this region where no unnecessary light exists.

FIG. 17b shows a case where the BD objective lens 108 shown in FIG. 1 has moved in the Y direction (radial direction of the BD information recording medium). A circle 1704 denotes a light beam reflected by the L0 layer and focused by the detecting lens and a region enclosed by a dotted line 1706 denotes the unnecessary light. The irradiation condition of the unnecessary light changes from the condition shown in FIG. 17a and the unnecessary light is irradiated onto part of D as shown with a hatched region 1707. Compared to FIG. 10b shown in the first embodiment, the number of light receiving surfaces irradiated with the unnecessary light is reduced. Moreover, no unnecessary light is irradiated onto S, Q, R, T at all as in the case of FIG. 10b. Therefore, TES is never disturbed as explained in the first embodiment and it is possible to obtain a stable tracking error signal when the BD objective lens 108 performs a tracking operation. Though the size of the optical sensor is a little larger than that in the first embodiment, MTES={(A+E)+(B+F)}−{(D+H)+(C+G)} shown by [Formula 3] above is more stable than the first embodiment, and as a result, it is possible to obtain an effect that TES=MTES−k×STES shown above by [Formula 5] above is less subject to unnecessary light from other layers and becomes more stable compared to the first embodiment. It is appreciated from FIG. 17a and FIG. 17b that the third light receiving surface 1603 (I, J) is arrange closer to the outermost circumference of the region irradiated with the unnecessary light shown by the single-dot dashed lines 1702 and 1705 compared to FIG. 10 in the first embodiment.

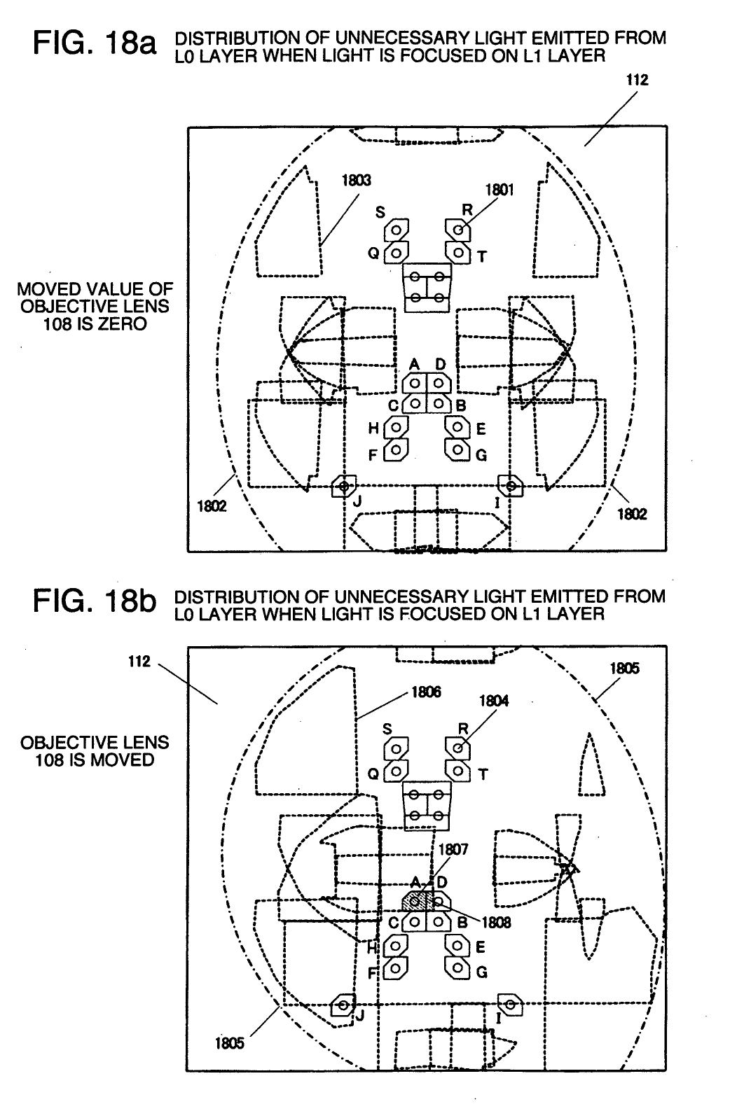

FIG. 18 shows a BD information recording medium having two data layers of an L0 layer (cover layer having a thickness of about 100 μm) and an L1 layer (cover layer having a thickness of about 75 μm) and an example of calculating, when light is focused on the target L1 layer, a distribution of unnecessary light reflected from the L0 layer which is a non-target layer and irradiated onto the light receiving portion 112 of the optical sensor 109. FIG. 18a shows a case where a value of movement of the objective lens 108 shown in FIG. 1 in the Y direction (radial direction of the BD information recording medium) is 0. A plurality of circles 1801 denote light beams reflected from the L1 layer and focused by a detecting lens and each signal expressed by [Formula 2] to [Formula 7] above is generated in accordance with the intensity of light irradiated onto each light receiving surface. The region enclosed by a dotted line 1803 denotes unnecessary light, which is divided into multiple portions by the light beam multiple-dividing element 104. Therefore, a region denoted by a single-dot dashed line 1802 where no unnecessary light exists is generated in the outermost circumference of the region irradiated with the unnecessary light enclosed by the dotted line 1803. The first light receiving surface 503, second light receiving surface 504, fourth light receiving surface 506 and fifth light receiving surface 507 shown above in FIG. 16 are arranged in this region where no unnecessary light exists.

FIG. 18b shows a case where the BD objective lens 108 shown in FIG. 1 has moved in the Y direction (radial direction of the BD information recording medium). A circle 1804 denotes a light beam reflected by the L1 layer and focused by the detecting lens and a region enclosed by a dotted line 1806 denotes unnecessary light. The irradiation condition of the unnecessary light changes from the condition shown in FIG. 18a and the unnecessary light is irradiated onto part of A and D as shown with hatched regions 1807 and 1808. Compared to FIG. 11b shown in the first embodiment, the number of light receiving surfaces irradiated with the unnecessary light is reduced. Moreover, no unnecessary light is irradiated onto S, Q, R, T at all as in the case of FIG. 11b. Therefore, TES is never disturbed as explained in the first embodiment and it is possible to obtain a stable tracking error signal when the BD objective lens 108 performs a tracking operation. Though the size of the optical sensor is a little larger than that in the first embodiment, MTES={(A+E)+(B+F)}−{(D+H)+(C+G)} shown by [Formula 3] is more stable than that of the first embodiment. As a result, it is possible to obtain an effect that TES=MTES−k×STES shown above by [Formula 5] is less subject to unnecessary light from other layers and a more stable characteristic is obtained compared to the first embodiment. It is appreciated from FIG. 18a and FIG. 18b that the third light receiving surface 1603 (I, J) is arranged closer to the outermost circumference of the region irradiated with unnecessary light shown by single-dot dashed lines 1802 and 1805 compared to FIG. 11 in the first embodiment.

### Fourth Embodiment

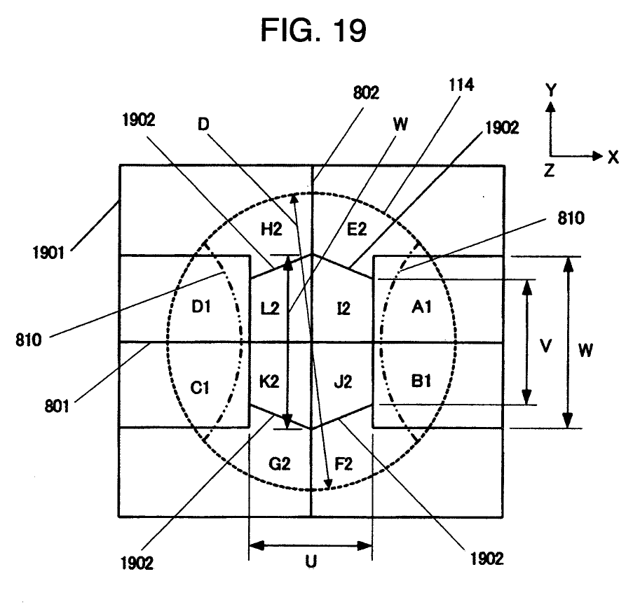

A fourth embodiment of the present invention will be explained using FIGS. 19 to 21. FIG. 19 shows a grating pattern formed in a light beam multiple-dividing element 1901 according to this embodiment and is constituted of a plurality of polarizing grating surfaces A1 to D1, E2 to L2. This embodiment differs from the light beam multiple-dividing element 104 of the first embodiment shown in FIG. 8 in that while the shape of the first grating region made up of the four polarizing grating surfaces 12, J2, K2, L2 is rectangular in the first embodiment, it is rhomboid (having four hypotenuses 1902) in this embodiment. Accordingly, the shape of the third grating region made up of four polarizing grating surfaces E2, F2, G2, H2 is also different from that in the first embodiment. The other parts are the same as those in the first embodiment and explanations thereof will be omitted here. This embodiment adopts the pattern in FIG. 16 shown in the third embodiment as the light receiving surface pattern of the light receiving portion 112 of the BD optical sensor 109.

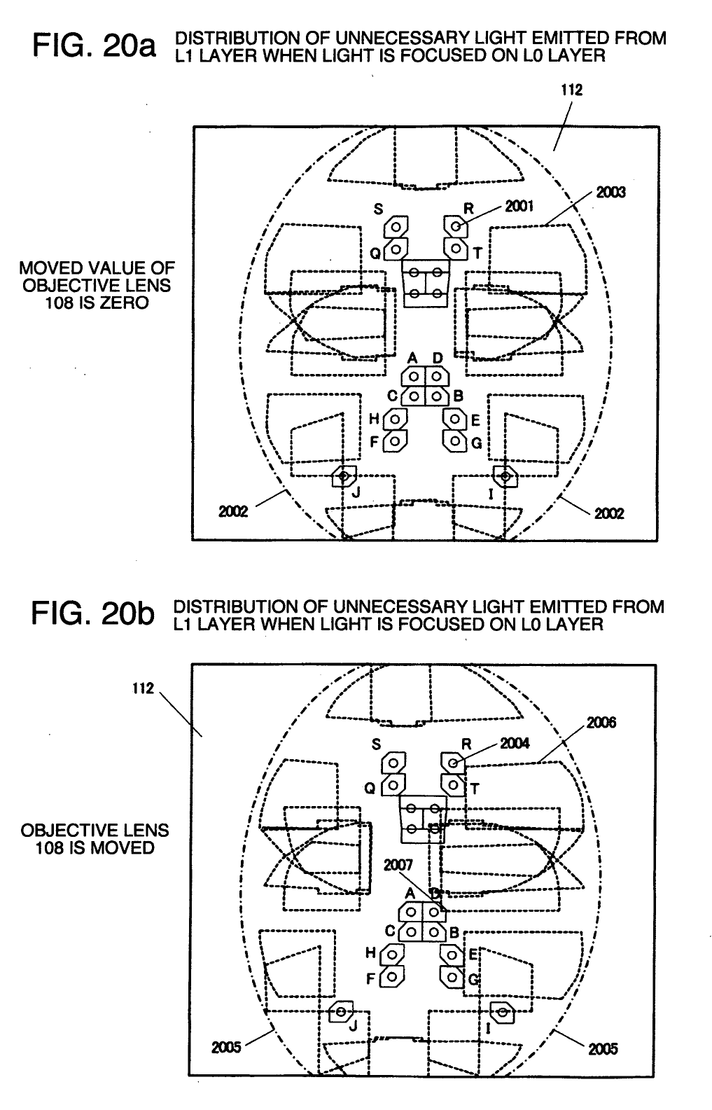

FIG. 20 shows a BD information recording medium having two data layers of an L0 layer (cover layer having a thickness of about 100 μm) and an L1 layer (cover layer having a thickness of about 75 μm) and an example of calculating, when light is focused on the target L0 layer, a distribution of unnecessary light reflected from the L1 layer which is a non-target layer and irradiated onto the light receiving portion 112 of the optical sensor 109. FIG. 20a shows a case where a value of movement of the BD objective lens 108 shown in FIG. 1 in the Y direction (radial direction of the BD information recording medium) is 0. A plurality of circles 2001 denote light beams reflected from the L0 layer and focused by a detecting lens and each signal expressed by [Formula 2] to [Formula 7] above is generated in accordance with the intensity of light irradiated onto each light receiving surface. The region enclosed by a dotted line 2003 denotes the unnecessary light, which is divided into multiple portions by the light beam multiple-dividing element 1901 shown in FIG. 19. Therefore, a region denoted by a single-dot dashed line 2002 where no unnecessary light exists is generated in the outermost circumference of the region irradiated with the unnecessary light enclosed by the dotted line 2003. The first light receiving surface 503, second light receiving surface 504, fourth light receiving surface 506 and fifth light receiving surface 507 shown above in FIG. 16 are arranged in this region where no unnecessary light exists.

FIG. 20b shows a case where the BD objective lens 108 shown in FIG. 1 has moved in the Y direction (radial direction of the BD information recording medium). A circle 2004 denotes a light beam reflected by the L0 layer and focused by the detecting lens and a region enclosed by a dotted line 2006 denotes unnecessary light. The condition of the unnecessary light changes from the condition shown in FIG. 20a and the unnecessary light is irradiated onto a tiny part of D as shown with a hatched region 2007. Compared to FIG. 17b shown in the third embodiment, the area irradiated with the unnecessary light is reduced in D. Moreover, no unnecessary light is irradiated onto S, Q, R, T at all as in the case of FIG. 17b. Therefore, TES is never disturbed as explained in the first embodiment and it is possible to obtain a stable tracking error signal when the BD objective lens 108 performs a tracking operation. In this case, though the shape of the light beam multiple-dividing element 1901 is a little more complicated than that in the third embodiment, MTES={(A+E)+(B+F)}−{(D+H)+(C+G)} shown by [Formula 3] is more stable. As a result, it is possible to obtain an effect that TES=MTES−k×STES shown above by [Formula 5] is less subject to unnecessary light from other layers and a more stable characteristic is obtained compared to the third embodiment.

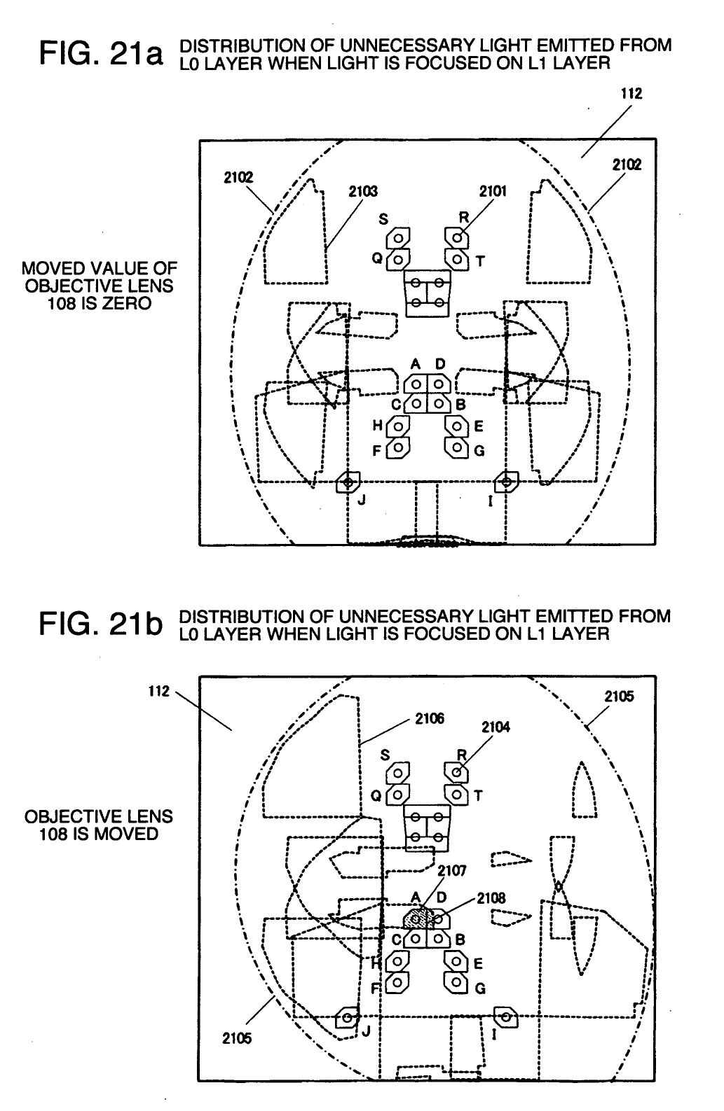

FIG. 21 shows a BD information recording medium having two data layers of an L0 layer (cover layer having a thickness of about 100 μm) and an L1 layer (cover layer having a thickness of about 75 μm) and an example of calculating, when light is focused on the target L1 layer, a distribution of unnecessary light reflected from the L0 layer which is a non-target layer and irradiated onto the light receiving portion 112 of the optical sensor 109. FIG. 21a shows a case where a value of movement of the BD objective lens 108 shown in FIG. 1 in the Y direction (radial direction of the BD information recording medium) is 0. A plurality of circles 2101 denote light beams reflected from the L1 layer and focused by a detecting lens and each signal expressed by [Formula 2] to [Formula 7] above is generated in accordance with the intensity of light irradiated onto each light receiving surface. A region enclosed by a dotted line 2103 denotes unnecessary light, which is divided into multiple portions by the light beam multiple-dividing element 1901 shown in FIG. 19. Therefore, a region denoted by a single-dot dashed line 2102 where no unnecessary light exists is generated in the outermost circumference of the region irradiated with the unnecessary light enclosed by the dotted line 2103. The first light receiving surface 503, second light receiving surface 504, fourth light receiving surface 506 and fifth light receiving surface 507 shown above in FIG. 16 are arranged in this region where no unnecessary light exists.

FIG. 21b shows a case where the BD objective lens 108 shown in FIG. 1 has moved in the Y direction (radial direction of the BD information recording medium). A circle 2104 denotes a light beam reflected by the L1 layer and focused by the detecting lens and a region enclosed by a dotted line 2106 denotes unnecessary light. The condition of the unnecessary light changes from the condition shown in FIG. 21a and the unnecessary light is irradiated onto part of A and D as shown with hatched regions 2107 and 2108. This condition is substantially the same as that in FIG. 18b shown in the third embodiment. Moreover, no unnecessary light is irradiated onto S, Q, R, T at all as in the case of FIG. 18b. Therefore, TES is never disturbed as explained in the first embodiment and it is possible to obtain a stable tracking error signal (TES) when the BD objective lens 108 performs a tracking operation. In this case, TES=MTES−k×STES shown by [Formula 5] is stable in the same way as in the third embodiment.

### Fifth Embodiment

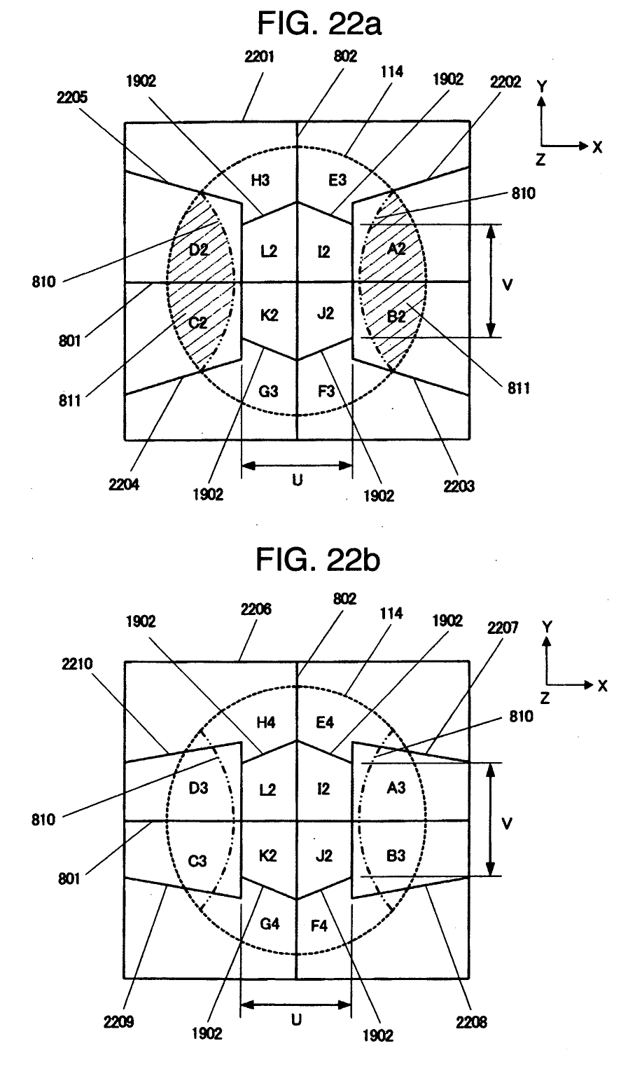

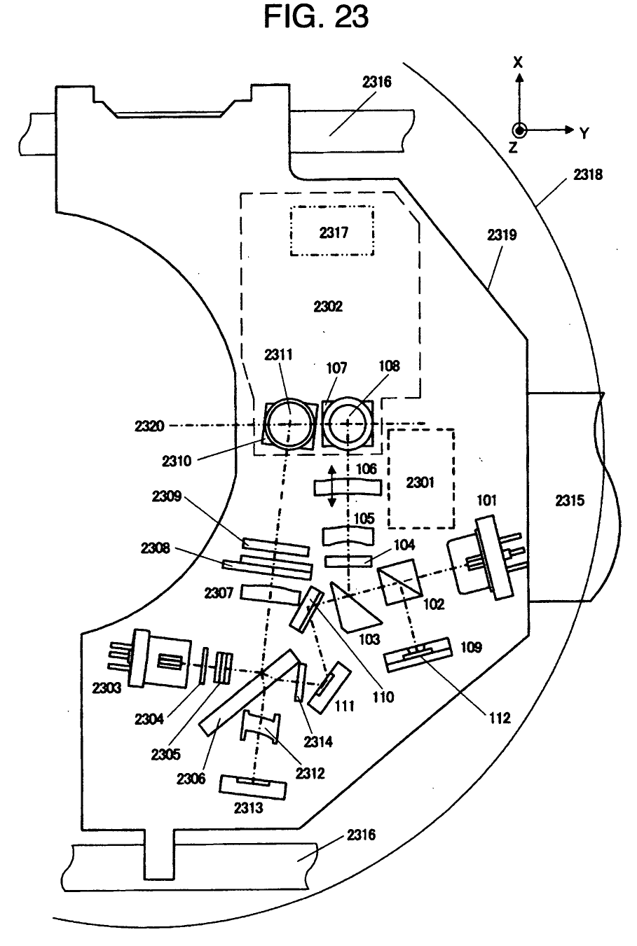

A fifth embodiment of the present invention will be explained using FIG. 22. This figure shows an example where the grating pattern of the light beam multiple-dividing element 1901 shown in FIG. 19 of the fourth embodiment is modified. In FIG. 22a, this embodiment differs from the fourth embodiment in that while the shape of the second grating region made up of the four polarizing grating surfaces A2, B2, C2, D2 is rectangular in the fourth embodiment, this embodiment adopts a trapezoidal shape provided with hypotenuses 2202, 2203, 2204 and 2205. Accordingly, the shape of the third grating region made up of the four polarizing grating surfaces E3, F3, G3, H3 is also different from that in the fourth embodiment. In this case, the polarizing grating surfaces A2, B2, C2, D2 are designed to completely include two push-pull regions which are regions enclosed by a two-dot dashed line 810 and a dotted line 114 where zero-order light and primary light diffracted by tracks of the information recording medium overlap each other (shown by hatched regions 811), which produces an effect that the signal amplitude of a tracking error signal (TES) increases. Furthermore, as shown in FIG. 22b, it is also possible to adopt a trapezoidal shape with hypotenuses 2207, 2208, 2209 and 2210 provided for the four polarizing grating surfaces A3, B3, C3, D3 which constitute the second grating region. Accordingly, the shape of the third grating region made up of four polarizing grating surfaces E4, F4, G4, H4 is different from that in FIG. 22a. In FIG. 22, the first grating region made up of the four polarizing grating surfaces 12, J2, K2, L2 is assumed to be rhomboid, but the shape thereof may also be rectangular as shown in FIG. 8a.

### Sixth Embodiment

The embodiments of the BD optical head have been explained so far, but this embodiment will explain an embodiment of three-wavelength compatible optical head for BD/DVD/CD.

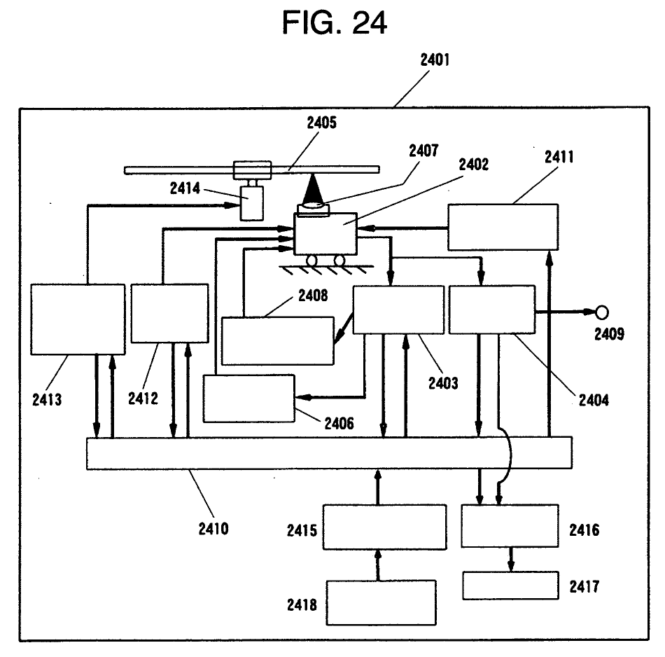

FIG. 23 shows an upper view of a three-wavelength compatible optical head for BD/DVD/CD. Since a BD optical system is basically the same as that in FIG. 1 of the first embodiment, detailed explanations thereof will be omitted and only parts not described in FIG. 1 will be explained. A region 2301 enclosed by a single-dot dashed line indicates a spherical aberration compensating mechanism which drives a BD collimating lens 106 in an optical axis direction shown by an arrow mark.

Next, the DVD/CD optical system will be explained. Reference numeral 2303 denotes a two-wavelength multilaser and is a laser beam source with two laser chips which emit light beams of different wavelengths mounted in a housing thereof. The two-wavelength multilaser 2303 is mounted with a DVD laser chip (not shown) which emits a light beam having a wavelength of about 660 nm and a CD laser chip (not shown) which emits a light beam having a wavelength of about 780 nm.

First, the DVD optical system will be explained. A DVD light beam of linearly polarized light is emitted from the DVD laser chip (not shown) of the two-wavelength multilaser 2303 as diverging light. The light beam emitted from the DVD laser chip (not shown) enters a wideband half wavelength plate 2304 and is thereby converted to linearly polarized light in a predetermined direction. When light beams in bands having a wavelength of about 660 nm and a wavelength of about 780 nm enter, the wideband half wavelength plate 2304 is an element which functions as a half wavelength plate for both wavelengths and is generally used for current DVD/CD compatible optical pickups.

The light beam then enters a wavelength selective diffraction grating 2305. The wavelength selective diffraction grating 2305 is an optical element which branches, when the light beam having a wavelength of about 660 nm enters, the light beam at a diffraction angle of θ1, and branches, when the light beam having a wavelength of about 780 nm, the light beam at a diffraction angle of θ2 which is different from the diffraction angle θ1. Such a wavelength selective diffraction grating 2305 can be manufactured by adjusting groove depths of the diffraction grating and diffractive index and is used for optical pickups mounted with a two-wavelength multilaser beam source in recent years. The light beam is branched by the wavelength selective diffraction grating 2305 into one main light beam and two sub-light beams, and the two sub-light beams are used to generate a signal based on DPP and differential astigmatic detection (DAD) method. Since the DPP and DAD methods are well known techniques, explanations thereof will be omitted here. The light beam which has passed through the wavelength selective diffraction grating 2305 is reflected by a dichroic half mirror 2306 and then converted to a substantially collimated light beam by a collimating lens 2307. The light beam which proceeds through the collimating lens 2307 enters a liquid crystal aberration compensating element 2308. This liquid crystal aberration compensating element 2308 has a function of compensating coma aberration in a predetermined direction for the DVD light beam. Furthermore, an electrode pattern is set to enable coma aberration to be compensated for a light beam of CD as well as DVD though the amount of compensation varies. The light beam which has passed through the liquid crystal aberration compensating element 2308 enters a wideband quarter wave length plate 2309, where it is converted to circularly polarized light. The wideband quarter wave length plate 2309 is also an optical element which functions as a quarter wave length plate for both DVD and CD light beams. The light beam which has passed through the wideband quarter wave length plate 2309 is reflected by a bending mirror 2310 in a Z direction, enters a DVD/CD compatible objective lens 2311, is focused on and irradiated onto an information recording medium 2318, a DVD data layer here. The DVD/CD compatible objective lens 2311 and BD objective lens 108 are mounted on an objective lens actuator (not shown) arranged in a region 2302 enclosed by a dotted line, and can be driven to translate in the Y direction and Z direction in the figure and driven to rotate around the X-axis.

The light beam reflected by the data layer proceeds through the DVD/CD compatible objective lens 2311, bending mirror 2310, wideband quarter wave length plate 2309, liquid crystal aberration compensating element 2308, collimating lens 2307, dichroic half mirror 2306 and detecting lens 2312 and reaches a DVD/CD optical sensor 2313. The light beam is given astigmatism when it passes through the dichroic half mirror 2306 and used to detect a focusing error signal (FES). The detecting lens 2312 has a function of rotating the direction of astigmatism in an arbitrary direction and at the same time determining the size of a focused spot on the DVD/CD optical sensor 2313. The light beam guided by the DVD/CD optical sensor 2313 is used to detect an information signal recorded in the DVD data layer and detect a position control signal of a focused spot focused and irradiated onto the DVD data layer such as a tracking error signal (TES) and focusing error signal (FES). Here, the left side of FIG. 23 corresponds to an inner circumference direction of the information recording medium 2318 and the right side corresponds to an outer circumference direction of the information recording medium 2318. The two objective lenses of the DVD/CD compatible objective lens 2311 and BD objective lens 108 are arranged side by side in the radial direction (Y direction) of the information recording medium 2318, but when an optical pickup is manufactured, optimum tilt angles of the DVD/CD compatible objective lens 2311 and BD objective lens 108 may vary in the radial direction and in the tangent direction of the information recording medium 2318. The liquid crystal aberration compensating element 2308 is mounted to compensate the difference in this optimum tilt angle. Since the difference in the tilt angle corresponds to coma aberration, the liquid crystal aberration compensating element 2308 has a function of compensating coma aberration in the radial direction (Y direction) and tangent direction (X direction) of the information recording medium 2318.

Next, the CD optical system will be explained. A CD light beam of linearly polarized light is emitted from the CD laser chip (not shown) of the two-wavelength multilaser 2303 as diverging light. The light beam emitted from the CD laser chip (not shown) enters the wideband half wavelength plate 2304 and is converted to linearly polarized light in a predetermined direction. The light beam then enters the wavelength selective diffraction grating 2305, is branched into one main light beam and two sub-light beams at a diffraction angle θ2 which is different from the above described diffraction angle θ1 and the two sub-light beams are used to generate DPP or DAD signals. The light beam which has passed through the wavelength selective diffraction grating 2305 is reflected by the dichroic half mirror 2306 and then converted by the collimating lens 2307 to a substantially collimated light beam. The light beam which has proceeded through the collimating lens 2307 enters the liquid crystal aberration compensating element 2308. The liquid crystal aberration compensating element 2308 has the function of compensating coma aberration in a predetermined direction also for a CD light beam. The light beam which has passed through the liquid crystal aberration compensating element 2308 enters the wideband quarter wave length plate 2309, where it is converted to circularly polarized light. The light beam which has passed through the wideband quarter wave length plate 2309 is reflected by the bending mirror 2310 in the Z direction, enters the DVD/CD compatible objective lens 2311 and focused and irradiated onto the data layer of CD.

The light beam reflected by the data layer of CD proceeds through the DVD/CD compatible objective lens 2311, bending mirror 2310, wideband quarter wave length plate 2309, liquid crystal aberration compensating element 2308, collimating lens 2307, dichroic half mirror 2306 and detecting lens 2312 and reaches the DVD/CD optical sensor 2313. When proceeding through the dichroic half mirror 2306, the light beam is given astigmatism in the same way as DVD, and used to detect a focusing error signal (FES). The detecting lens 2312 also has the function of rotating the direction of astigmatism of the CD light beam in an arbitrary direction in the same way as for the DVD light beam and at the same time determining the size of a focused spot at the DVD/CD optical sensor 2313. The light beam guided by the DVD/CD optical sensor 2313 is used to detect the information signal recorded in the CD data layer and detect a position control signal of a focused spot focused and irradiated onto the CD data layer such as a tracking error signal (TES) and focusing error signal (FES).

A light receiving surface of a front monitor 111 is disposed near the center of light intensity distribution in a direction horizontal (θ// direction) and direction perpendicular (θ⊥direction) to a chip activation layer of the two-wavelength multilaser 2303. Reference numeral 2317 denotes a laser driver IC to control the amount of light emission of the BD laser beam source 101 and two-wavelength multilaser 2303. Reference numeral 2315 denotes an FPC which electrically connects the optical head and the electric circuit board (not shown of this embodiment).

As described above, by using the two-wavelength multilaser 2303 and mounting the above described optical parts on the optical head housing 2319, it is possible to provide a compatible optical head for three media of BD, DVD and CD. An optical head housing 2319 is supported by two guide shafts 2316. Furthermore, the DVD/CD compatible objective lens 2311 which is the first objective lens and the BD objective lens 108 which is the second objective lens are arranged side by side in the radial direction (Y direction) of the information recording medium 2318, and the DVD/CD optical system and the BD optical system are provided in the space on the same side with respect to an axis 2320 connecting the DVD/CD compatible objective lens 2311 and BD objective lens 108 inside the same optical head housing 2319. Adopting such a configuration has effects of being able to secure the performance of each optical system and further facilitate assembly and adjustment of the optical system. The three-wavelength compatible optical head shown in this embodiment is intended for a slim type optical head and can be expected to be mounted on apparatuses such as a slim type drive mounted on a notebook personal computer, portable drive, optical disk movie camera.

### Seventh Embodiment

The first to sixth embodiments have explained the embodiments related to the optical head according to the present invention so far, and here an embodiment of an optical information reproducing apparatus or optical information recording/reproducing apparatus mounted with the above described optical head will be explained using FIG. 24. FIG. 24 is a schematic block diagram of an information recording/reproducing apparatus 2401 which records and reproduces information. Reference numeral 2402 denotes the optical head of the present invention and a signal detected from this optical head 2402 is sent to a servo signal generation circuit 2403 and an information signal reproducing circuit 2404 inside a signal processing circuit. The servo signal generation circuit 2403 generates a focus control signal, tracking control signal and spherical aberration detection signal suitable for an optical disk medium 2405 from the signal detected by the optical head 2402, drives an objective lens actuator (not shown) inside the optical head 2402 through an objective lens actuator driving circuit 2406 based on these signals, and performs position control over an objective lens 2407. Furthermore, the above described servo signal generation circuit 2403 generates a spherical aberration detection signal by the optical head 2402 and drives a compensating lens of a spherical aberration compensating optical system (not shown) inside the optical head 2402 through a spherical aberration compensating driving circuit 2408 based on this signal. Furthermore, the information signal reproducing circuit 2404 reproduces an information signal recorded in an optical disk medium 2405 from the signal detected from the optical head 2402 and outputs the information signal to an information signal output terminal 2409. Incidentally, part of the signal obtained at the servo signal generation circuit 2403 and information signal reproducing circuit 2404 is sent to a system control circuit 2410. The system control circuit 2410 sends a laser driving recording signal, drives a laser beam source lighting circuit 2411, controls the amount of light emission using a front monitor (not shown) and records a recording signal into the optical disk medium 2405 through the optical head 2402. This system control circuit 2410 is connected to an access control circuit 2412 and a spindle motor driving circuit 2413, which perform access direction position control of the optical head 2402 and rotation control of a spindle motor 2414 of the optical disk 2405 respectively. When the user controls the information recording/reproducing apparatus 2401, the user instructs a user input processing circuit 2415 to perform control. Processing conditions or the like of the information recording/reproducing apparatus in such a case are displayed by a display processing circuit 2416.

It should be further understood by those skilled in the art that although the foregoing description has been made on embodiments of the invention, the invention is not limited thereto and various changes and modifications may be made without departing from the spirit of the invention and the scope of the appended claims.

1. An optical head comprising,
a laser source,
a collimating lens for converting a light beam emitted by the laser source to a collateral beam,
a spherical aberration compensating mechanism for moving the collimating lens along an optical axis,
an objective lens for focusing the light beam emitted by the laser source onto an information recording surface of an information recording medium,
a detecting lens for receiving the light beam reflected by the information recording surface,
a light beam multiple-dividing element for dividing the light beam reflected by the information recording surface to a plurality of sub-light beams, and
an optical sensor for receiving the sub-light beams to be converted to respective electric signals,
wherein the optical sensor includes first light receiving surfaces each of which has one of pentagonal shape and hexagonal shape and which are independent of each other on one of sides opposite to each other through a first imaginary central line corresponding to a radial direction of the information recording medium and being parallel to the radial direction of the information recording medium, second light receiving surfaces each of which has the hexagonal shape and which are arranged at an outside of the first light receiving surfaces on the one of the sides, third light receiving surfaces each of which has the hexagonal shape and which are arranged at an outside of the second light receiving surfaces on the one of the sides, fourth light receiving surfaces two of which have respective rectangular shapes, the other two of which have respective trapezoidal shapes, and which are independent of each other on the other one of the sides, and fifth light receiving surfaces each of which has the hexagonal shape and which are arranged at an outside of the fourth light receiving surfaces on the other one of the sides.

2. An optical head comprising,
a laser source,
a collimating lens for converting a light beam emitted by the laser source to a collateral beam,
a spherical aberration compensating mechanism for moving the collimating lens along an optical axis,
an objective lens for focusing the light beam emitted by the laser source onto an information recording surface of an information recording medium,
a detecting lens for receiving the light beam reflected by the information recording surface,
a light beam multiple-dividing element for dividing the light beam reflected by the information recording surface to a plurality of sub-light beams, and
an optical sensor for receiving the sub-light beams to be converted to respective electric signals,
wherein the light beam multiple-dividing element is partitioned by a first line segment parallel to an imaginary straight line extending on two push-pull regions overlapped by a zero-order light and +primary lights reflected by the information recording medium to be diffracted and a second line segment perpendicular to the first line segment to include a first grating area including grating surfaces being independent of each other and arranged symmetrical with respect to an intersecting point of the first and second line segments, a second grating area including four grating surfaces being independent of each other, arranged at an outside of the first grating area and arranged symmetrical with respect to the first line segment, and a third grating area including four grating surfaces being independent of each other, arranged at an outside of the first grating area and arranged symmetrical with respect to the second line segment so that the light beam reflected by the information recording surface of the information recording medium is received by the first, second and third grating areas to be diffracted to form the +primary lights and the −primary lights.

3. The optical head according to claim 1, wherein the light beam multiple-dividing element is partitioned by a first line segment parallel to an imaginary straight line extending on two push-pull regions overlapped by a zero-order light and ±primary lights reflected by the information recording medium to be diffracted and a second line segment perpendicular to the first line segment to include a first grating area including grating surfaces being independent of each other and arranged symmetrical with respect to an intersecting point of the first and second line segments, a second grating area including four grating surfaces being independent of each other, arranged at an outside of the first grating area and arranged symmetrical with respect to the first line segment, and a third grating area including four grating surfaces being independent of each other, arranged at an outside of the first grating area and arranged symmetrical with respect to the second line segment so that the light beam reflected by the information recording surface of the information recording medium is received by the first, second and third grating areas to be diffracted to form the +primary lights and the −primary lights, and four of the −primary lights formed by the diffraction of the four grating surfaces of the second grating area are received by a dark line as a boundary among the fourth light receiving surfaces of the rectangular shapes and trapezoidal shapes when being focused on the information recording surface of the information recording medium.

4. The optical head according to claim 1, wherein the light beam multiple-dividing element is partitioned by a first line segment parallel to an imaginary straight line extending on two push-pull regions overlapped by a zero-order light and ±primary lights reflected by the information recording medium to be diffracted and a second line segment perpendicular to the first line segment to include a first grating area including grating surfaces being independent of each other and arranged symmetrical with respect to an intersecting point of the first and second line segments, a second grating area including four grating surfaces being independent of each other, arranged at an outside of the first grating area and arranged symmetrical with respect to the first line segment, and a third grating area including four grating surfaces being independent of each other, arranged at an outside of the first grating area and arranged symmetrical with respect to the second line segment so that the light beam reflected by the information recording surface of the information recording medium is received by the first, second and third grating areas to be diffracted to form the +primary lights and the −primary lights, the +primary lights formed by the diffraction of the four grating surfaces of the second grating area to be received by the first light receiving surfaces and the +primary lights formed by the diffraction of the four grating surfaces of the third grating area to be received by the second light receiving surfaces are used to generate a main tracking error signal, and the −primary lights formed by the diffraction of the four grating surfaces of the third grating area to be received by the fifth light receiving surfaces are used to generate a sub-tracking error signal so that a tracking error signal is calculated by a differential operation from the main tracking error signal and the sub-tracking error signal.

5. The optical head according to claim 1, wherein the light beam multiple-dividing element is partitioned by a first line segment parallel to an imaginary straight line extending on two push-pull regions overlapped by a zero-order light and ±primary lights reflected by the information recording medium to be diffracted and a second line segment perpendicular to the first line segment to include a first grating area including grating surfaces being independent of each other and arranged symmetrical with respect to an intersecting point of the first and second line segments, a second grating area including four grating surfaces being independent of each other, arranged at an outside of the first grating area and arranged symmetrical with respect to the first line segment, and a third grating area including four grating surfaces being independent of each other, arranged at an outside of the first grating area and arranged symmetrical with respect to the second line segment so that the light beam reflected by the information recording surface of the information recording medium is received by the first, second and third grating areas to be diffracted to form the +primary lights and the −primary lights, the +primary lights formed by the diffraction of the four grating surfaces of the second grating area to be received by the first light receiving surfaces, the +primary lights formed by the diffraction of the four grating surfaces of the third grating area to be received by the second light receiving surfaces and the +primary lights formed by the diffraction of the four grating surfaces of the first grating area to be received by the third light receiving surfaces are used to generate a reproducing signal.

6. The optical head according to claim 1, wherein the −primary lights formed by the diffraction of the four grating surfaces of the third grating area to be received by the fifth light receiving surfaces are used to generate a signal indicating a radial position of the objective lens on the information recording medium.

7. The optical head according to claim 1, wherein the light beam multiple-dividing element is partitioned by a first line segment parallel to an imaginary straight line extending on two push-pull regions overlapped by a zero-order light and ±primary lights reflected by the information recording medium to be diffracted and a second line segment perpendicular to the first line segment to include a first grating area including grating surfaces being independent of each other and arranged symmetrical with respect to an intersecting point of the first and second line segments, a second grating area including four grating surfaces being independent of each other, arranged at an outside of the first grating area and arranged symmetrical with respect to the first line segment, and a third grating area including four grating surfaces being independent of each other, arranged at an outside of the first grating area and arranged symmetrical with respect to the second line segment so that the light beam reflected by the information recording surface of the information recording medium is received by the first, second and third grating areas to be diffracted to form the +primary lights and the −primary lights, and a focal distance of the detecting lens is shorter than a focal distance of the collimating lens.

8. The optical head according to claim 2, wherein the grating surfaces of the light beam multiple-dividing element are polarizing grating surfaces, and the light beam multiple-dividing element further includes a quarter wavelength plate.

9. The optical head according to claim 2, wherein intensities of the +primary lights formed by the diffraction of the grating surfaces of the first grating area are higher than intensities of the −primary lights.

10. The optical head according to claim 1, wherein the light beam multiple-dividing element is partitioned by a first line segment parallel to an imaginary straight line extending on two push-pull regions overlapped by a zero-order light and ±primary lights reflected by the information recording medium to be diffracted and a second line segment perpendicular to the first line segment to include a first grating area including grating surfaces being independent of each other and arranged symmetrical with respect to an intersecting point of the first and second line segments, a second grating area including four grating surfaces being independent of each other, arranged at an outside of the first grating area and arranged symmetrical with respect to the first line segment, and a third grating area including four grating surfaces being independent of each other, arranged at an outside of the first grating area and arranged symmetrical with respect to the second line segment so that the light beam reflected by the information recording surface of the information recording medium is received by the first, second and third grating areas to be diffracted to form the +primary lights and the −primary lights, the light beam multiple-dividing element distributes a part of the light beam focused on one of a plurality of the information recording surfaces which part is reflected by the other at least one of the information recording surfaces as an unnecessary light, to form a clearance region on the optical sensor surrounded by the unnecessary light to be prevented from receiving the unnecessary light, and the first, second, third, fourth and fifth light receiving surfaces are arranged on the clearance region.

11. The optical head according to claim 10, wherein the fifth light receiving surfaces are arranged to prevent from receiving the unnecessary light even when the objective lens moves radially on the information recording medium.

12. An optical information recording and reproducing apparatus comprising the optical head according to claim 1, a laser drive circuit for driving the laser source, a servo-signal generator for generating a servo-signal from an output signal of the optical sensor of the optical head, an information signal reproducing circuit for reproducing an information out of the information recording medium from another output signal of the optical sensor of the optical head, and a system control circuit for controlling the laser drive circuit, the servo-signal generator and the information signal reproducing circuit.

13. An optical head comprising,
a laser source for emitting a laser beam,
an objective lens for focusing the laser beam on an optical disk,
a dividing element for dividing the laser beam reflected by the optical disk to a plurality of light beams, and
an optical sensor for receiving the light beams as light spots,
wherein the optical sensor includes a light receiving surface for receiving at least one of the light beams, and a shape of the light receiving surface is elongated in a direction along which the light spot moves when the laser beam is defocused on the optical disk.

14. The optical disk according to claim 13, wherein the optical sensor is partitioned by an imaginary partitioning line corresponding to a radial direction of the optical disk and parallel to the radial direction to have sides opposite to each other through the imaginary partitioning line, the optical sensor has first and second ones of the light receiving surfaces as one of the sides, the first one of the light receiving surfaces is arranged between the imaginary partitioning line and the second one of the light receiving surfaces, and the direction in which the first one of the light receiving surfaces is elongated is different from the direction in which the second one of the light receiving surfaces is elongated.
